(19) United States
(12) Patent Application Publication
(10) Pub. No.: US 2025/0179309 A1
(43) Pub. Date: Jun. 5, 2025

(54) BELOW GRADE WATERPROOFING WITH BENTONITE

(71) Applicant: GCP Applied Technologies Inc., Alpharetta, GA (US)

(72) Inventors: Samuel TREVENEN, Tewksbury, MA (US); Xiao Zhao, Chelmsford, MA (US); Marysusan Couturier, Framingham, MA (US); Xia Cao, Acton, MA (US); Jyoti Seth, Andover, MA (US); Todd P. Dinoia, Littleton, MA (US)

(21) Appl. No.: 18/962,761

(22) Filed: Nov. 27, 2024

Related U.S. Application Data
(60) Provisional application No. 63/604,602, filed on Nov. 30, 2023.
(60) Provisional application No. 63/567,296, filed on Mar. 19, 2024.
(60) Provisional application No. 63/567,272, filed on Mar. 19, 2024.
(60) Provisional application No. 63/567,276, filed on Mar. 19, 2024.

(51) Int. Cl. C09D 5/16; C04B 41/00; C04B 41/47; C04B 41/63; C09D 7/61; C09D 7/65; C09D 195/00

(52) U.S. Cl. CPC C09D 5/1656; C04B 41/009; C04B 41/478; C04B 41/63; C09D 7/61; C09D 7/65; C09D 195/00

(57) ABSTRACT

Disclosed are waterproofing compositions and waterproofing articles, such as waterproofing membranes comprising such waterproofing compositions. The waterproofing composition can include a hydrophobic binder and a swellable filler. The hydrophobic binder can include at least one of (i) a polymer modified asphalt comprising an asphalt and a polymer additive; (ii) a hot melt adhesive; and/or (iii) a thermoplastic polymer. The swellable filler can include at least one of (a) at least 15 wt. % and no greater than 85 wt. % of a swellable clay, and/or (b) at least 0.1 wt. % and no greater than 70 wt. % of a super absorbent polymer, wherein the amounts in wt. % are based on a total weight of the waterproofing composition.

### CROSS REFERENCE TO RELATED APPLICATIONS

This application claims priority under 35 U.S.C. § 119 (c) to U.S. Provisional Patent Application No. 63/604,602, entitled “BELOW GRADE WATERPROOFING WITH BENTONITE,” filed Nov. 30, 2023, by Samuel TREVENEN et al., and claims priority under 35 U.S.C. § 119 (c) to U.S. Provisional Patent Application No. 63/567,296, entitled “BELOW GRADE WATERPROOFING WITH BENTONITE,” filed Mar. 19, 2024, by Samuel TREVENEN et al., and claims priority under 35 U.S.C. § 119 (c) to U.S. Provisional Patent Application No. 63/567,272, entitled “BELOW GRADE WATERPROOFING WITH BENTONITE,” filed Mar. 19, 2024, by Samuel TREVENEN et al., and claims priority under 35 U.S.C. § 119 (c) to U.S. Provisional Patent Application No. 63/567,276, entitled “BELOW GRADE WATERPROOFING WITH SUPER ABSORBENT POLYMER,” filed Mar. 19, 2024, by Samuel TREVENEN et al., the entire disclosures of each of these is incorporated herein by reference for all purposes.

### FIELD OF THE DISCLOSURE

The present invention relates to waterproofing compositions and layered sheets including waterproofing compositions for below grade waterproofing application and methods in building and construction.

### BACKGROUND

Pre-applied waterproofing, sometimes called “blind-side” or “reverse tanking” waterproofing, refers to an established practice in which a membrane is positioned against a substrate, such as horizontal or vertical formwork or “lagging,” subsequent to which a fresh concrete is “post-cast” against the membrane to form a building structure (e.g., a foundation) or a civil engineering structure (e.g., tunnel). In other words, waterproofing is installed first, and building is “cast” afterward.

Pre-applied waterproofing must be trafficable by humans, so that various construction materials may be installed before the concrete is cast.

Some waterproofing membranes can be designed to swell. It may be desirable to have membranes that swell immediately upon contact with water. It may be alternatively desirable to for a membrane to exhibit delayed swelling, in case of rain, snow, etc. occurring after the pre-applied waterproofing is applied but before the concrete is cast.

There exists a need for improved waterproofing membranes.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

In one aspect a waterproofing composition comprises:
a hydrophobic binder, the hydrophobic binder comprising at least one of the following:
   a) a polymer modified asphalt comprising asphalt and a polymer additive;
   b) a hot melt adhesive; and
   c) a thermoplastic polymer;
and
a swellable filler comprising at least one of the following:
(i) at least 15 wt. % and no greater than 85 wt. % of a swellable clay, and
(ii) at least 0.1 wt. % and no greater than 70 wt. % of a super absorbent polymer;
   wherein the amounts in wt. % are based on a total weight of the waterproofing composition.

### BRIEF DESCRIPTION OF THE DRAWINGS

The present disclosure may be better understood, and its numerous features and advantages made apparent to those skilled in the art by referencing the accompanying drawings.

FIG. 1A illustrates a cross-sectional view of a portion of a waterproofing article according to embodiments of the present invention.

FIG. 1B illustrates a cross-sectional view of a portion of an alternative waterproofing article according to embodiments of the present invention.

FIG. 2A illustrates a cross-sectional view of a portion of a waterproofing article according to embodiments of the present invention.

FIG. 2B illustrates a cross-sectional view of a portion of an alternative waterproofing article according to embodiments of the present invention.

FIG. 2C illustrates a cross-sectional view of a portion of an alternative waterproofing article according to embodiments of the present invention.

FIG. 3 schematically illustrates an apparatus for shaping the waterproofing compositions for swell testing.

FIGS. 4A and 4B shows a plot of swelling by way of mass increase (Δ Mass (%)) over water immersion time for various waterproofing compositions.

FIG. 5 shows a plot of maximum swelling by way of maximum mass increase (Δ Mass (%)) as a function of bentonite concentration for two different waterproofing compositions.

FIG. 6 shows a plot of viscosity as a function of bentonite concentration for various waterproofing compositions.

FIG. 7 shows a plot of bond to concrete for various functional layers with variable mass of granules deposited thereon.

FIG. 8 shows a plot of viscosity as a function of bentonite concentration for various waterproofing compositions.

FIGS. 9A and 9B show plots of viscosity as a function of swelling for various waterproofing compositions.

FIGS. 10A and 10B each shows a plot of maximum swelling (Maximum Δ Mass (%)) as a function of time for various waterproofing compositions.

FIGS. 11A and 11B show a plot of swelling (Δ Mass (%)) over time for various waterproofing compositions.

FIGS. 12A and 12B show images of swollen waterproofing compositions.

FIG. 13 shows a plot of swelling (Δ Mass (%)) over time for various waterproofing compositions.

FIG. 14 shows a plot of swelling variation over time for various waterproofing compositions.

FIG. 15 shows a plot of swelling (Δ Mass (%)) over time for various waterproofing compositions swelling while submerged in different solutions.

FIGS. 16A, 16B, and 16C shows a plot of swelling (Δ Mass (%)) over time for various waterproofing compositions.

FIG. 17 shows a plot of swelling (Δ Mass (%)) over time for various waterproofing compositions.

FIG. 18 shows a plot of swelling (Δ Mass (%)) over time for various waterproofing compositions.

### DETAILED DESCRIPTION

The following is directed to waterproofing compositions. The waterproofing compositions can be applied in below grade waterproofing applications. The waterproofing compositions include a hydrophobic binder and a swellable filler. The waterproofing compositions can be used as a functional layer in a waterproofing article, such as a waterproofing membrane.

According to one aspect, a waterproofing composition can comprise a hydrophobic binder and a swellable filler dispersed in the hydrophobic binder. In an embodiment the swellable filler is substantially uniformly dispersed in the hydrophobic binder.

### Waterproofing Compositions-Binders

In an embodiment, the hydrophobic binder may include a particular composition that may facilitate improved performance and/or manufacturing of the waterproofing composition. In an embodiment, the hydrophobic binder can include at least one of the following:
1) A polymer modified asphalt comprising asphalt and a polymer additive;
2) A hot melt adhesive; and
3) A thermoplastic polymer.

In another embodiment, the hydrophobic binder comprises a polymer modified asphalt comprising asphalt and a polymer additive. The asphalt can be oxidized asphalt, or non-oxidized asphalt. The asphalt can be solid at room temperature. The asphalt may be virgin asphalt or recycled asphalt. The asphalt may also be an asphalt emulsion.

In an embodiment, the waterproofing composition can include a particular asphalt content that may facilitate improved performance and/or manufacturing of the waterproofing composition. In an embodiment the waterproofing composition can include at least 5 wt. % asphalt or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % asphalt based on a total weight of the waterproofing composition. In an embodiment, the waterproofing composition may include no greater than 99 wt. % asphalt or no greater than 95 wt. % or no greater than 90 wt. % or no greater than 85 wt. % or no greater than 80 wt. % or no greater than 75 wt. % or no greater than 70 wt. % or no greater than 65 wt. % or no greater than 60 wt. % or no greater than 55 wt. % or no greater than 50 wt. % or no greater than 45 wt. % or no greater than 40 wt. % or no greater than 35 wt. % or no greater than 30 wt. % or no greater than 25 wt. % or no greater than 20 wt. % or no greater than 15 wt. % or no greater than 10 wt. % asphalt based on a total weight of the waterproofing composition. It will be appreciated that the asphalt content of the waterproofing composition may be between any of the minimum and maximum values noted above, including for example, but not limited to, at least 5 wt. % asphalt and not greater than 90 wt. % asphalt or at least 40 wt. % asphalt and not greater than 50 wt. % asphalt or at least 30 wt. % and not greater than 80 wt. %, based on a total weight of the waterproofing composition.

In an embodiment, the polymer modified asphalt of the waterproofing composition may include a particular polymer additive that may facilitate improved performance and/or manufacturing of the waterproofing composition. In an embodiment, the polymer additive can include an acrylic modifier, a tackifier, atactic polypropylene, isotactic polypropylene, ethylene vinylacetate, styrenic block copolymers, polyvinyl butyral, paraffinic oligomers, virgin or recycled rubbers, butyl rubber, polyolefin block copolymers, polymeric microspheres, or a combination thereof. In another embodiment, the polymer additive can include thermoplastic elastomers including, but not limited to, styrene-butadiene (SBR), styrene-butadiene-styrene (SBS) or styrene-isoprene-styrene (SIS). The styrene-butadiene-styrene can be a radial or a linear polymer; the radial SBS having a star-like branching structure, while the linear SBS having a straight chain structure. The SBS rubber can include diblock content. In a preferred embodiment, the styrene-butadiene-styrene rubber is a radial polymer. In another embodiment, the hydrophobic binder comprises a polymer modified asphalt, sometimes referred to as a rubberized asphalt.

In an embodiment, the waterproofing composition may have a particular ratio of asphalt content:polymer additive content that may facilitate improved performance and/or manufacturing of the waterproofing composition. In an embodiment, the waterproofing composition may include a ratio of asphalt content:polymer additive content of at least 0.1:1 or at least 0.5:1 or at least 1:1 or at least 1.5:1 or at least 2:1 or at least 2.5:1 or at least 3:1 or at least 3.5:1 or at least 4:1 or at least 4.5:1 or at least 5:1 or at least 5.5:1 or at least 6:1 or at least 6.5:1 or at least 7:1 or at least 7.5:1 or at least 8:1 or at least 8.5:1 or at least 9:1. In another embodiment, the waterproofing composition may include a ratio of asphalt content:polymer content no greater than 100:1 or no greater than 90:1 or no greater than 80:1 or no greater than 70:1 or no greater than 60:1 or no greater than 50:1 or no greater than 40:1 or no greater than 30:1 or no greater than 20:1 or no greater than 15:1 or no greater than 12:1 or no greater than 10:1 or no greater than 5:1. It will be appreciated that the ratio of asphalt content:polymer content may be between any of the minimum and maximum values noted above, including for example, but not limited to at least 3:1 and not greater than 20:1 or at least 4:1 and not greater than 20:1 or at least 4:1 and not greater than 15:1 or at least 4:1 and not greater than 12:1.

In an embodiment, the waterproofing composition may have a particular polymer additive content that may facilitate improved performance and/or manufacturing of the waterproofing composition. In an embodiment of the waterproofing composition, the polymer modified asphalt can include the polymer additive in an amount of at least 1 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. %, based on a total weight of the waterproofing composition. In another embodiment of the waterproofing composition, the polymer modified asphalt can include the polymer additive in an amount of no greater than 85 wt. % or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % or no greater than 19 wt. % or no greater than 18 wt. % or no greater than 17 wt. % or no greater than 16 wt. % or no greater than 15 wt. % or no greater than 14 wt. % or no greater than 13 wt. % or no greater than 12 wt. % or no greater than 11 wt. % or no greater than 10 wt. % or no greater than 9 wt. % or no greater than 8 wt. % or no greater than 7 wt. % or no greater than 6 wt. % or no greater than 5 wt. %, based on a total weight of the waterproofing composition. It will be appreciated that the polymer additive content may be between any of the minimum and maximum values noted above, including for example, but not limited to at least 1 wt. % and no greater than 20 wt. % or at least 11 wt. % and no greater than 44 wt. % or at least 2 wt. % and no greater than 15 wt. % or at least 2 wt. % and no greater than 12 wt. %, or at least 2 wt. % and no greater than 10 wt. %, based on a total weight of the waterproofing composition.

In an embodiment, the hydrophobic binder can further include a rheology modifier. The rheology modifier may have a particular composition that may facilitate improved performance and/or manufacturing of the waterproofing composition. In an embodiment the rheology modifier can include a process oil, paraffinic wax, castor wax, a colloidal additive,-amide wax, surface active agent, or a combination thereof. In an embodiment, the rheology modifier includes a process oil. Suitable examples of process oil include, but are not limited to, Aromatic oil, Naphthenic oil, Paraffinic oil or combinations thereof.

In an embodiment, the waterproofing composition may have a particular ratio of asphalt content:rheology modifier content that may facilitate improved performance and/or manufacturing of the waterproofing composition. In an embodiment, the waterproofing composition may include a ratio of asphalt content:rheology modifier content of at least 0.1:1 or at least 0.5:1 or at least 1:1 or at least 1.5:1 or at least 2:1 or at least 2.5:1 or at least 3:1 or at least 3.5:1 or at least 4:1 or at least 4.5:1 or at least 5:1 or at least 5.5:1 or at least 6:1 or at least 6.5:1 or at least 7:1 or at least 7.5:1 or at least 8:1 or at least 8.5:1 or at least 9:1. In another embodiment, the waterproofing composition may include a ratio of asphalt content:rheology modifier content of no greater than 100:1 or no greater than 90:1 or no greater than 80:1 or no greater than 70:1 or no greater than 60:1 or no greater than 50:1 or no greater than 40:1 or no greater than 30:1 or no greater than 25:1 or no greater than 20:1 or no greater than 20:1 or no greater than 15:1 or no greater than 10:1 or no greater than 5:1. It will be appreciated that the ratio of asphalt content:rheology modifier content may be between any of the minimum and maximum values noted above, including for example, but not limited to at least 3:1 and not greater than 20:1 or at least 5:1 and not greater than 20:1 or at least 4:1 and not greater than 15:1 or at least 4:1 and not greater than 12:1.

In an embodiment, the waterproofing composition may have a particular rheology modifier content that may facilitate improved performance and/or manufacturing of the waterproofing composition. In an embodiment, the waterproofing composition can include rheology modifier in an amount of at least 1 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % based on a total weight of the waterproofing composition. In another embodiment, the waterproofing composition can include rheology modifier in an amount of no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % rheology modifier or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % or no greater than 19 wt. % or no greater than 18 wt. % or no greater than 17 wt. % or no greater than 16 wt. % or no greater than 15 wt. % or no greater than 14 wt. % or no greater than 13 wt. % or no greater than 12 wt. % or no greater than 11 wt. % or no greater than 10 wt. % or no greater than 9 wt. % or no greater than 8 wt. % or no greater than 7 wt. % or no greater than 6 wt. % or no greater than 5 wt. %, based on a total weight of the waterproofing composition. It will be appreciated that the rheology modifier content may be between any of the minimum and maximum values noted above, including for example, but not limited to at least 1 wt. % and no greater than 20 wt. % or at least 11 wt. % and no greater than 44 wt. % or at least 2 wt. % and no greater than 15 wt. % or at least 2 wt. % and no greater than 10 wt. %, based on a total weight of the waterproofing composition.

In an embodiment of the waterproofing composition, the hydrophobic binder comprises a hot melt adhesive. Any suitable hydrophobic hot met adhesive may be used, including, but not limited to, rubber-modified bituminous adhesive and synthetic polymer adhesives (non-bituminous) based on the following polymers such as butyl rubber, polyisobutylene, styrene-isoprene-styrene (SIS), styrene ethylene-butylene-styrene (SEBS), styrene-butadiene-styrene (SBS), styrene butadiene rubber (SBR), amorphous polyolefin (APO), polyvinyl acetate (PVAc), ethylene-vinyl acetate (EVA), polyurethane (PU), Acrylics, Acrylate, polyamides, polyamide or any combination thereof.

In an embodiment of the waterproofing composition, the hydrophobic binder comprises a thermoplastic polymer. Any suitable hydrophobic thermoplastic polymer may be used, including, but not limited to, Polyethylene (PE), Polypropylene (PP), Polystyrene (PS), Polyvinyl chloride (PVC), polyurethane (PU), Polyacrylic and copolymer, Polylactic acid (PLA), Polyacrylate and copolymers, ethylene-vinyl acetate (EVA), Acrylonitrile butadiene styrene (ABS), Polyethylene terephthalate (PET), Polyphenylene oxide (PPO), Polyether ether ketone (PEEK), Polyamides, etc.

In another embodiment of the waterproofing composition, the hydrophobic binder comprises a mixture of polymer modified asphalt and a thermoplastic polymer. In another embodiment of the waterproofing composition, the hydrophobic binder comprises a mixture pf polymer modified asphalt and a hot melt adhesive. In another embodiment of the waterproofing composition, the hydrophobic binder comprises a mixture of a hot melt adhesive, and a thermoplastic polymer. In yet another embodiment of the waterproofing composition, the hydrophobic binder comprises a mixture of polymer modified asphalt, a hot melt adhesive, and a thermoplastic polymer.

### Waterproofing Compositions—Swellable Fillers

In an embodiment, the swellable filler may include a particular composition that may facilitate improved performance and/or manufacturing of the waterproofing composition. As used herein, a “swellable filler” is any material that increases in mass or volume by at least 30% when immersed in excess water until the swelling system reaches equilibrium. In an embodiment the swellable filler includes swellable clay. The swellable clay may include smectite, bentonite, bentonite salt, vermiculite, montmorillonite, nontronite, saponite, or combinations thereof. In an embodiment, the second swellable filler may include smectite or bentonite or a bentonite salt. In an embodiment, the bentonite salt may be sodium bentonite, potassium bentonite, calcium bentonite, magnesium bentonite, aluminum bentonite, or a combination thereof. In an alternative embodiment, the bentonite may include sodium bentonite. In an embodiment, the swellable clay may have a median particle size, of 10 to 2000 microns, or 20 to 1000 microns or 50 to 200 microns. Particle sizes of swellable clays may be determined using US standard mesh screens.

In another embodiment, the swellable filler includes a super absorbent polymer. As used herein, a “super absorbent polymer” is any polymer that increases in mass or volume by at least 30% when put in immersed in excess water for sufficient time for the swelling to cease via said polymer absorbing the water. As used herein, the super absorbent polymers of the present application are substantially insoluble in water due to being cross-linked or having substantially high molecular weight if un-crosslinked. In an embodiment, the super absorbent polymer may include a particular composition that may facilitate improved performance and/or manufacturing of the waterproofing composition. The super absorbent polymer may include a polyacrylate copolymer, a polyacrylamide copolymer, a polyvinyl alcohol copolymer, polyethylene oxide copolymer, a maleic anhydride copolymer, a cellulose graft copolymer, a starch acrylonitrile graft copolymer, or a combination thereof. The super absorbent polymer may include a polyacrylate copolymer insoluble in water due to having a high molecular weight or due to being crosslinked. In an embodiment, the super absorbent polymer may include a crosslinked sodium polyacrylate. In an embodiment, the super absorbent polymer may have a median particle size of 10 to 1000 microns, or 20 to 400 microns, or 50 to 200 microns. Particle sizes of superabsorbent polymers may be with light scattering using 405 and 650 nm light source with a Horiba LA-950v2 detector.

In another embodiment, the swellable filler includes a combination of a super absorbent polymer and a swellable clay.

In an embodiment, the waterproofing composition can include a particular swellable clay content that may facilitate improved performance and/or manufacturing of the waterproofing composition. In an embodiment the waterproofing composition can include swellable clay in an amount of at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % based on a total weight of the waterproofing composition. In an embodiment, the waterproofing composition may include swellable clay in an amount of no greater than 85 wt. % or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 60 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % based on a total weight of the waterproofing composition. It will be appreciated that the swellable clay content of the waterproofing composition may be between any of the minimum and maximum values noted above, including for example, but not limited to, at least 15 wt. % swellable clay and not greater than 85 wt. % swellable clay or at least 30 wt. % swellable clay and not greater than 50 wt. % swellable clay or at least 25 wt. % swellable clay and not greater than 70 wt. % swellable clay or at least 30 wt. % swellable clay and not greater than 65 wt. % swellable clay or at least 35 wt. % swellable clay and not greater than 60 wt. % swellable clay, based on the total weight of the composition, where the amounts in wt. % are based on the total weight of the waterproofing composition.

In an embodiment, the waterproofing composition can include a particular super absorbent polymer content that may facilitate improved performance and/or manufacturing of the waterproofing composition. In an embodiment the waterproofing composition can include super absorbent polymer in an amount of at least 0.1 wt. % or at least 0.5 wt. % or at least 1 wt. % or at least 1.5 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % based on a total weight of the waterproofing composition. In an embodiment, the waterproofing composition may include no greater than 70 wt. % or no greater than 65 wt. % or no greater than 60 wt. % or no greater than 55 wt. % or no greater than 50 wt. % or no greater than 45 wt. % or no greater than 40 wt. % or no greater than 35 wt. % or no greater than 30 wt. % or no greater than 25 wt. % or no greater than 20 wt. % or no greater than 15 wt. % or no greater than wt. % or no greater than 10 wt. %. It will be appreciated that the super absorbent polymer content of the waterproofing composition may be between any of the minimum and maximum values noted above, including for example, but not limited to, at least 5 wt. % super absorbent polymer and not greater than 25 wt. % super absorbent polymer or at least 10 wt. % super absorbent polymer and not greater than 50 wt. % super absorbent polymer or 15 wt. % super absorbent polymer and not greater than 25 wt. % super absorbent polymer or 12 wt. % super absorbent polymer and not greater than 22 wt. % super absorbent polymer %, where the amounts in wt. % are based on the total weight of the waterproofing composition.

In an embodiment, the waterproofing composition can include a particular total swellable filler content that may facilitate improved performance and/or manufacturing of the waterproofing composition. In an embodiment the waterproofing composition can include total swellable filler, including swellable clay and/or super absorbent polymer, in an amount of at least 0.1 wt. % or at least 0.5 wt. % or at least 1 wt. % or at least 1.5 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % based on a total weight of the waterproofing composition. In an embodiment, the waterproofing composition may include total swellable filler, including swellable clay and/or super absorbent polymer, in an amount of no greater than 85 wt. % or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 60 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 45 wt. % or no greater than 40 wt. % or no greater than 35 wt. % or no greater than 30 wt. % or no greater than 25 wt. % or no greater than 20 wt. % or no greater than 15 wt. % or no greater than wt. % or no greater than 10 wt. % based on a total weight of the waterproofing composition. It will be appreciated that the total swellable filler content of the waterproofing composition may be between any of the minimum and maximum values noted above, including for example, but not limited to, at least 15 wt. % total swellable filler and not greater than 85 wt. % total swellable filler or at least 30 wt. % total swellable filler and not greater than 50 wt. % total swellable filler or at least 15 wt. % total swellable filler and not greater than 40 wt. % total swellable filler or at least 15 wt. % total swellable filler and not greater than 50 wt. % total swellable filler, where the amounts in wt. % are based on the total weight of the waterproofing composition.

In an embodiment, the waterproofing composition may have a particular ratio of swellable clay content:binder content that may facilitate improved performance and/or manufacturing of the waterproofing composition. In an embodiment, the waterproofing composition may include a ratio of swellable clay content:binder content of at least 0.1:1 or at least 0.2:1 or at least 0.3:1 or at least 0.4:1 or at least 0.5:1 or at least 0.6:1 or at least 0.7:1 or at least 0.8:1 or at least 0.9:1 or at least 1:1 or at least 1.1:1 or at least 1.2:1. In another embodiment, the waterproofing composition may include a ratio of swellable clay content:binder content of no greater than 100:1 or no greater than 90:1 or no greater than 80:1 or no greater than 70:1 or no greater than 60:1 or no greater than 50:1 or no greater than 40:1 or no greater than 30:1 or no greater than 20:1 or no greater than 15:1 or no greater than 12:1 or no greater than 10:1 or no greater than 5:1 or not greater than 3:1 or not greater than 1:1. It will be appreciated that the ratio of swellable clay content:binder content may be between any of the minimum and maximum values noted above, including for example, but not limited to at least 0.3:1 and not greater than 20:1 or at least 0.4:1 and not greater than 20:1 or at least 0.4:1 and not greater than 15:1 or at least 0.4:1 and not greater than 12:1.

In an embodiment, the waterproofing composition may have a particular ratio of super absorbent polymer content:binder content that may facilitate improved performance and/or manufacturing of the waterproofing composition. In an embodiment, the waterproofing composition may include a ratio of super absorbent polymer content:binder content of at least 0.01:1 or at least 0.05:1 or at least 0.1:1 or at least 0.2:1 or at least 0.3:1 or at least 0.4:1 or at least 0.5:1 or at least 0.6:1 or at least 0.7:1 or at least 0.8:1 or at least 0.9:1 or at least 1:1 or at least 1.1:1 or at least 1.2:1. In another embodiment, the waterproofing composition may include a ratio of super absorbent polymer content:binder content of no greater than 100:1 or no greater than 90:1 or no greater than 80:1 or no greater than 70:1 or no greater than 60:1 or no greater than 50:1 or no greater than 40:1 or no greater than 30:1 or no greater than 20:1 or no greater than 15:1 or no greater than 12:1 or no greater than 10:1 or no greater than 5:1 or not greater than 3:1 or not greater than 1:1. It will be appreciated that the ratio of super absorbent polymer content:binder content may be between any of the minimum and maximum values noted above, including for example, but not limited to at least 0.3:1 and not greater than 20:1 or at least 0.4:1 and not greater than 20:1 or at least 0.4:1 and not greater than 15:1 or at least 0.4:1 and not greater than 12:1.

### Waterproofing Compositions—Inert Fillers and Other Additives

In an embodiment, the waterproofing composition may further include an inert filler that may provide improved performance and/or manufacturing of the waterproofing composition. In an embodiment, the inert filler can include limestone, talc, mica, slag, sly ash, cement, hydrate cement, aluminum trihydrate, aluminum oxide, silica (e.g. fume silica, amorphous silica), perlite, rock flower, magnesium hydroxide, magnesium silicate, calcium sulfate, diatomaceous earth, zinc oxide, glass beads, titanium dioxide, zinc borate, kaolin, colemanite, ceramics, carbon black, silica, glass fiber, a fire retardant, a renewable filler, or a combination thereof. In some embodiments, the inert filler includes fillers that do not dissociate or slightly dissociate in water (having a dissociation constant K<10⁻¹¹), or that do not include multivalent cations, such as for example, including but are not limited to, silica, aluminum trihydrate, and diatomaceous earth. As used herein, the dissociation constant is a solubility product constant equal to the product of the concentration of the ions when the filler is dissolved in an aqueous solution long enough to reach equilibrium. This constant should be measured at 25° C. and 1 atm.

Fillers that do not dissociate in water or have a dissociation constant, K<10⁻¹¹, do not interfere with swelling and are preferred. Similarly, fillers without multivalent cations such as calcium are also preferred. Further, monovalent cations such as sodium, found in swellable and inert fillers such as sodium bentonite can be included to mitigate downsides of including multivalent cations. Accordingly, in some embodiments, it can be preferred to include fillers, swellable and/or inert, with monovalent cations when fillers, swellable and/or inert, with multivalent cations are used in the waterproofing compositions.

In an embodiment, the waterproofing composition can include a particular inert filler content that may provide improved performance and/or manufacturing of the waterproofing composition. In an embodiment, the waterproofing composition can include an inert filler content of at least 0.1 wt. % or at least 1 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % based on a total weight of the waterproofing composition. In an embodiment, the waterproofing composition can include an inert filler content of no greater than 65 wt. % or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % based on a total weight of the waterproofing composition. It will be appreciated that the inert filler content of the waterproofing composition may be between any of the minimum and maximum values noted above, including for example, but not limited to at least 43 wt. % and no greater than 65 wt. % or at least 0.1 wt. % and no greater than 39 wt. % or at least 15 wt. % and no greater than 65 wt. % or at least 35 wt. % and no greater than 65 wt. % where the amounts in wt. % are based on the total weight of the waterproofing composition.

In an embodiment, the waterproofing composition can include a particular total filler content (including swellable and inert fillers) that may provide improved performance and/or manufacturing of the waterproofing composition. In an embodiment, the waterproofing composition can include a total filler content of at least 0.1 wt. % or at least 1 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % based on a total weight of the waterproofing composition. In an embodiment, the waterproofing composition can include a total filler content of no greater than 85 wt. % or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % based on a total weight of the waterproofing composition. It will be appreciated that the inert filler content of the waterproofing composition may be between any of the minimum and maximum values noted above, including for example, but not limited to at least 43 wt. % and no greater than 65 wt. % or at least 0.1 wt. % and no greater than 39 wt. % or at least 15 wt. % and no greater than 65 wt. % or at least 35 wt. % and no greater than 65 wt. % where the amounts in wt. % are based on the total weight of the waterproofing composition.

In an embodiment, the waterproofing composition can further include a functional additive that may provide improved performance and/or manufacturing of the waterproofing composition. In an embodiment, the functional additive can include an antioxidant, an anti-caking agent, a UV stabilizer, a thermal stabilizer, a colorant, an adhesion promoter, or a combination thereof.

### Waterproofing Compositions—Properties

In an embodiment, the waterproofing composition may have a particular maximum swelling percentage that may facilitate improved performance and/or manufacturing of the waterproofing composition. The maximum swelling percentage may depend on if the swellable filler 102 includes swellable clay, super absorbent polymer, or both. More specifically, the maximum swelling percentage will often be much higher when the swellable filler includes a super absorbent polymer. The maximum swelling percentage used herein interchangeably with maximum swelling is defined in the examples section of this application, as the maximum increase in mass percentage when immersed in excess water until the swelling system reaches equilibrium.

In some embodiments the waterproofing composition comprising a binder and a swellable filler including a swellable clay and not including a super absorbent polymer, can have a maximum swelling percentage of at least 25% or at least 30% or at least 35% or at least 40% or at least 45% or at least 50% or at least 55% or at least 60% or at least 65% or at least 70% or at least 75% or at least 80% or at least 85% or at least 90% or at least 95% or at least 100% or at least 110% or at least 120% or at least 130% or at least 140% or at least 150% or at least 160% or at least 170% or at least 180% or at least 190% or at least 200% or at least 210% or at least 220% or at least 230% or at least 240% or at least 250%. In embodiments the waterproofing composition comprising a binder and a swellable filler including a swellable clay and not including a super absorbent polymer, can have a maximum swelling percentage of no greater than 300% or no greater than 290% or no greater than 280% or no greater than 270% or no greater than 260% or no greater than 250%. It will be appreciated that the waterproofing composition can have maximum swelling percentage between any of the minimum and maximum values noted above, including for example, but not limited to, at least 30 wt. % and no greater than 300 wt. % or at least 35 wt. % and no greater than 280 wt. % or at least 40 wt. % and no greater than 250 wt. %.

In some embodiments, the waterproofing composition comprising a binder and a swellable filler including a super absorbent polymer can have a maximum swelling percentage of at least 50% or at least 100% or at least 150% or at least 200% or at least 250% or at least 300% or at least 350% or at least 400% or at least 450% or at least 500% or at least 550% or at least 600% or at least 650% or at least 700% or at least 750% or at least 800% or at least 850% or at least 1000%. In embodiments the waterproofing composition comprising a binder and a swellable filler including a super absorbent polymer can have a maximum swelling percentage of no greater than 10000% or no greater than 9500% or no greater than 9000% or no greater than 8500% or no greater than 8000% or no greater than 7500% or no greater than 7000% or no greater than 6500% or no greater than 6000% or no greater than 5500% or no greater than 5000% or no greater than 4500% or no greater than 4000% or no greater than 3500% or no greater than 3000%. It will be appreciated that the waterproofing composition can have a maximum swelling percentage between any of the minimum and maximum values noted above, including for example, but not limited to, at least 250% and no greater than 3000% or at least 650% and no greater than 3500% or at least 600% and no greater than 3000% or at least 750% n and no greater than 4000%.

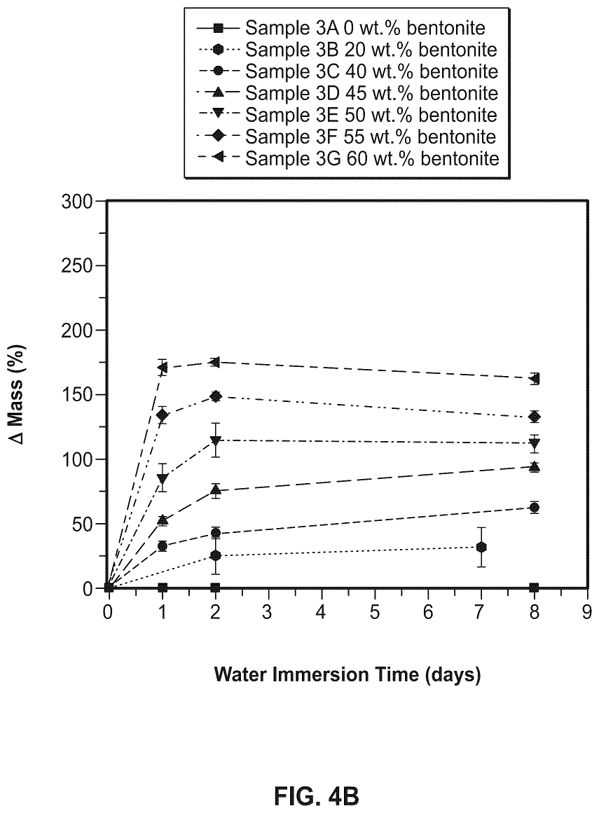

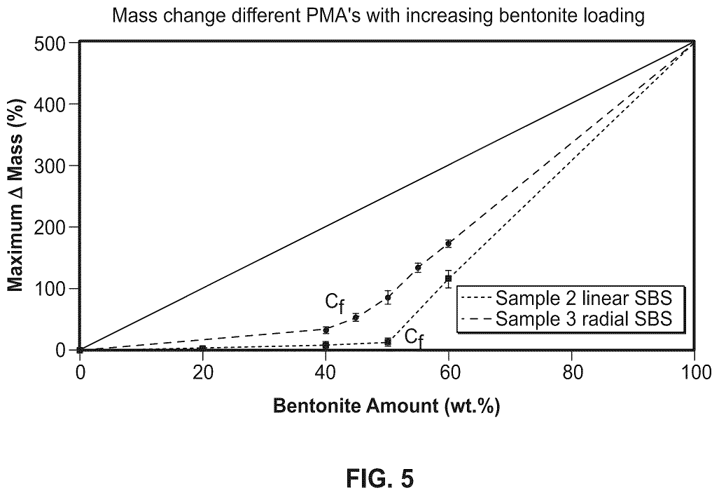

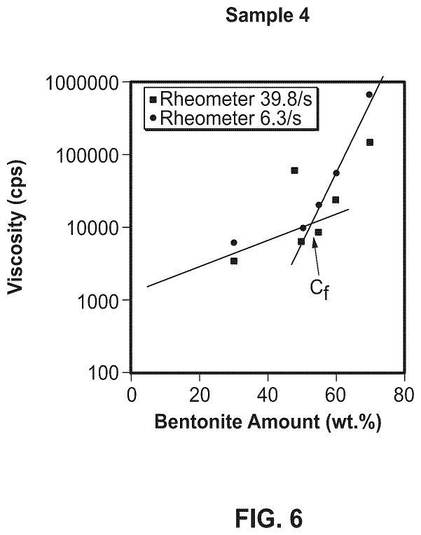

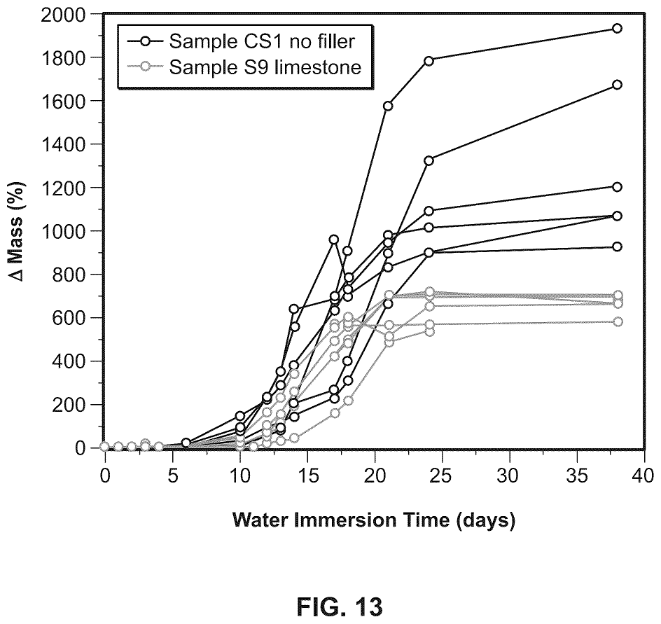

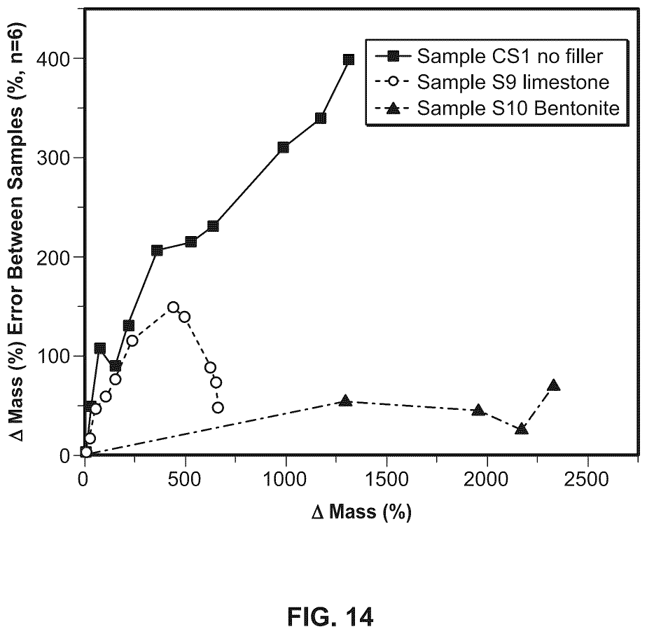

In an embodiment, the waterproofing composition can include a particular critical filler concentration C_{f} that may provide improved performance and/or manufacturing of the waterproofing composition. When the amount of filler (swellable or inert) exceeds the critical filler concentration C_{f}, a number of property changes are observes such as, improved swelling consistency (FIGS. 13 and 14), a larger increase in swelling per amount additional swellable filler added (FIGS. 4 and 5), and larger increase in viscosity per amount of filler added (FIG. 6). Methods of measuring C_{f} are detailed in the examples. In an embodiment, the C_{f} may be at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. %, based on the total weight of the waterproofing composition. In an alternative embodiment, the C_{f} may be no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % or no greater than 19 wt. % or no greater than 18 wt. % or no greater than 17 wt. % or no greater than 16 wt. % or no greater than 15 wt. % or no greater than 14 wt. % or no greater than 13 wt. % or no greater than 12 wt. % or no greater than 11 wt. % or no greater than 10 wt. % or no greater than 9 wt. % or no greater than 8 wt. % or no greater than 7 wt. % or no greater than 6 wt. % or no greater than 5 wt. %, based on the total weight of the waterproofing composition. It will be appreciated that the C_{f} may be between any of the minimum and maximum values noted above, including for example, but not limited to, at least 30 wt. % and not greater than 80 wt. % or at least 35 wt. % and not greater than 75 wt. % or at least 30 wt. % and not greater than 60 wt. % or at least 35 wt. % and not greater than 55 wt. %.

The inventors have found that the composition has beneficial material properties when the amount of swellable filler is at or around the critical filler concentration. In certain embodiments, the difference between the concentration of swellable filler and the critical filler concentration C_{f} may be no greater than 20 wt. % or no greater than 18 wt. % or no greater than 16 wt. % or no greater than 14 wt. % or no greater than 12 wt. % or no greater than 10 wt. % or no greater than 8 wt. % or no greater than 6 wt. % or no greater than 5 wt. %, based on the total weight of the waterproofing composition. In certain embodiments, the difference between the concentration of total filler, including both swellable filler and inert filler, and the critical filler concentration C_{f} may be no greater than 20 wt. % or no greater than 18 wt. % or no greater than 16 wt. % or no greater than 14 wt. % or no greater than 12 wt. % or no greater than 10 wt. % or no greater than 8 wt. % or no greater than 6 wt. % or no greater than 5 wt. %, based on the total weight of the waterproofing composition.

In an embodiment, the waterproofing composition may have a particular swelling consistency factor that may facilitate improved performance and/or manufacturing of the waterproofing composition. The swelling consistency factor may be found by plotting the standard deviation of swelling ((Δ Mass (%)) of 6 samples of a waterproofing composition for sufficient time for the swelling systems to reach equilibrium. The maximum standard deviation recorded is the swelling consistency factor. In an embodiment, the waterproofing composition can have a swelling consistency factor of no greater than 400% or no greater than 350% or no greater than 300% or no greater than 250% or no greater than 200% or no greater than 150%.

In an embodiment, the waterproofing composition may have a particular viscosity at 375° F. that may facilitate improved performance and/or manufacturing of the waterproofing composition. In an embodiment, the waterproofing composition may have a viscosity at 375° F. of no greater than 1,500,000 cps or no greater than 1,000,000 cps or no greater than 500,000 cps or no greater than 100,000 cps or no greater than 90,000 cps or no greater than 80,000 cps or no greater than 70,000 cps or no greater than 60,000 cps or no greater than 50,000 cps or no greater than 40,000 cps or no greater than 30,000 cps or no greater than 20,000 cps or no greater than 10,000 cps. In an embodiment, the waterproofing composition may have a viscosity at 375° F. of at least 1 cps. It will be appreciated that the viscosity of the waterproofing composition at 375° F. may be between any of the minimum and maximum values noted above, including at least 1 cps and not greater than 30,000 cps or at least 1 cps and not greater than 1,000,000 cps or at least 1 and no greater than 40,000 cps or at least 1 and no greater than 20,000 cps.

In an embodiment, the waterproofing compositions comprising PMA with variable bentonite and no SAP may have a particular swelling per viscosity factor (bentonite), SV_{B}, that may facilitate improved performance and/or manufacturing of the waterproofing composition. SV_{B} measures the change in maximum swelling per change in viscosity with the increase of the bentonite loading in the waterproofing composition. A large SV_{B} is desirable as it is indicative of a binder that can swell easily without becoming too viscous. Method of measuring SV_{B} can be found in the examples. In an embodiment, the hydrophobic binder may have an SV_{B} of at least 0.001 mass gain %/cps or at least 0.005 mass gain %/cps or at least 0.01 mass gain %/cps or at least 0.015 mass gain 9%/cps or at least 0.02 mass gain %/cps. In an embodiment, the hydrophobic binder may have an SV_{B} of no greater than 0.05 mass gain %/cps or no greater than 0.04 mass gain %/cps or no greater than 0.03 mass gain %/cps or no greater than 0.02 mass gain %/cps. It will be appreciated that the SV_{B} of the hydrophobic binder may be between any of the minimum and maximum values noted above include for example, but not limited to, at least 0.001 mass gain %/cps and no greater than 0.05 mass gain 9%/cps or at least 0.005 mass gain %/cps and no greater than 0.03 mass gain %/cps or at least 0.01 mass gain %/cps and no greater than 0.03 mass gain %/cps.

In an embodiment, the hydrophobic binder may have a particular swelling per viscosity factor (super absorbent polymer), SV_{P}, which may facilitate improved performance and/or manufacturing of the waterproofing composition. SV_{P} measures the change in maximum swelling per change in viscosity as you increase the super absorbent polymer loading for a particular binder. A large SV_{P} is desirable as it is indicative of a binder that can swell easily without becoming too viscous. Methods of measuring SV_{P} can be found in the examples. In an embodiment, the hydrophobic binder may have an SV_{P} of at least 0.01 mass gain %/cps or at least 0.05 mass gain %/cps or at least 0.1 mass gain %/cps or at least 0.2 mass gain %/cps or at least 0.3 mass gain 9%/cps or at least 0.4 mass gain %/cps or at least 0.5 mass gain %/cps or at least 0.6 mass gain %/cps or at least 0.7 mass gain %/cps or at least 08 mass gain %/cps or at least 0.9 mass gain %/cps or at least 1 mass gain %/cps. In an embodiment, the hydrophobic binder may have an SV_{P} of no greater than 20 mass gain %/cps or no greater than 18 mass gain %/cps or no greater than 16 mass gain %/cps or no greater than 14 mass gain %/cps or no greater than 12 mass gain %/cps or no greater than 10 mass gain %/cps or no greater than 8 mass gain %/cps or no greater than 6 mass gain %/cps. It will be appreciated that the SV_{P} of the hydrophobic binder may be between any of the minimum and maximum values noted above including for example, but not limited to at least 0.01 mass gain %/cps and no greater than 14 mass gain %/cps or at least 0.05 mass gain 9%/cps and no greater than 20 mass gain %/cps or at least 0.2 mass gain %/cps and no greater than 10 mass gain %/cps.

In an embodiment, the waterproofing composition can have a particular swelling ratio, maximum swelling percentage:swellable filler concentration, which may provide improved performance and/or manufacturing of the waterproofing composition. The swelling ratio may depend on the relative amounts of the different swellable fillers such as swellable clays and super absorbent polymers. More super absorbent polymer tends to result in more swelling per filler. The composition of the hydrophobic binder can also affect the amount of swelling relative to the amount of swellable filler. In an embodiment, the particular swelling ratio, maximum swelling percentage:swellable filler concentration, can be at least 0.1:1 or at least 0.2:1 or at least 0.3:1 or at least 0.4:1 or at least 0.5:1 or at least 0.6:1 or at least 0.7:1 or at least 0.8:1 or at least 09:1 or at least 1:1 or at least 1.1:1 or at least 1.2:1 or at least 1.3:1 or at least 1.4:1 or at least 1.5:1 or at least 1.6:1 or at least 1.7:1 or at least 1.8:1 or at least 1.9:1 or at least 2:1 or at least 2.1:1 or at least 2.2:1 or at least 2.3:1 or at least 2.4:1 or at least 2.5:1 or at least 2.6:1 or at least 2.7:1 or at least 2.8:1 or at least 2.9:1 or at least 3:1 or at least 3.1:1 or at least 3.2:1 or at least 3.3:1 or at least 3.4:1 or at least 3.5:1 or at least 3.6:1 or at least 3.7:1 or at least 3.8:1 or at least 3.9:1 or at least 4:1 or at least 4.1:1 or at least 4.2:1 or at least 4.3:1 or at least 4.4:1 or at least 4.5:1 or at least 4.6:1 or at least 4.7:1 or at least 4.8:1 or at least 4.9:1 or at least 5:1 or at least 6:1 or at least 7:1 or at least 8:1 or at least 9:1 or at least 10:1. In an alternative embodiment, the swelling ratio, maximum swelling percentage:swellable filler concentration, may be no greater than 50:1 or no greater than 150:1 or no greater than 140:1 or no greater than 130:1 or no greater than 120:1 or no greater than 110:1 or no greater than 100:1 or no greater than 90:1 or no greater than 80:1 or no greater than 70:1 or no greater than 60:1 or no greater than 50:1 or no greater than 45:1 or no greater than 40:1 or no greater than 35:1 or no greater than 30:1 or no greater than 25:1 or no greater than 20:1 or no greater than 15:1 or no greater than 10:1 or no greater than 5:1 or no greater than 4.9:1 or no greater than 4.8:1 or no greater than 4.7:1 or no greater than 4.6:1 or no greater than 4.5:1 or no greater than 4.4:1 or no greater than 4.3:1 or no greater than 4.2:1 or no greater than 4.1:1 or no greater than 4.0:1 or no greater than 3.9:1 or no greater than 3.8:1 or no greater than 3.7:1 or no greater than 3.6:1 or no greater than 3.5:1 or no greater than 3.4:1 or no greater than 3.3:1 or no greater than 3.2:1 or no greater than 3.1:1 or no greater than 3.0:1 or no greater than 2.9:1 or no greater than 2.8:1 or no greater than 2.7:1 or no greater than 2.6:1 or no greater than 2.5:1 or no greater than 2.4:1 or no greater than 2.3:1 or no greater than 2.2:1 or no greater than 2.1:1 or no greater than 2.0:1 or no greater than 1.9:1 or no greater than 1.8:1 or no greater than 1.7:1 or no greater than 1.6:1 or no greater than 1.5:1 or no greater than 1.4:1 or no greater than 1.3:1 or no greater than 1.2:1 or no greater than 1.1:1 or no greater than 1.0:1 or no greater than 0.9:1 or no greater than 0.8:1 or no greater than 0.7:1 or no greater than 0.6:1 or no greater than 0.5:1 or no greater than 0.4:1 or no greater than 0.3:1 or no greater than 0.2:1 or no greater than 0.1:1. It will be appreciated that the swelling ratio, maximum swelling percentage:swellable filler concentration, may be between any of the minimum and maximum values noted above including for example, but not limited to at least 0.1:1 and no greater than 20:1 or at least 1:1 and no greater than 30:1 or at least 0.5:1 and no greater than 150:1.

### Waterproofing Compositions—Binder Stiffness

In an embodiment, the hydrophobic binder may have a particular “stiffness” that may facilitate improved performance and/or manufacturing of the waterproofing composition. Stiffness of the binders, and more specifically, the polymer modified asphalt binders described herein can depend on a number of variables including the type of polymer/rubber additives, the type of rheology modifiers such as process oils, the relative amounts of asphalt, polymer, and rheology modifiers. As used herein, polymer modified asphalt binder having a viscosity>1200 cps at 375° F. can be considered “stiff” while binders having a viscosity≤1200 cps at 375° F. can be considered a “soft” polymer modified asphalt. Generally, a soft binder will allow greater swelling and is thus preferred as long as it is still processable. However, stiff binders can be preferred for certain applications as such binders can be used to control the timing of swelling as detailed below, as well as prevent deswelling as described above in the “Waterproofing Compositions—Inert Fillers and Other Additives” section.

### Waterproofing Compositions—Delayed Swelling

While many applications will call for a waterproofing compositions that swells immediately upon contact with water, some particular applications may call for a waterproofing composition or article that exhibits delayed swelling. As detailed in the examples section, the inventors have found a number of compositions that exhibit delayed swelling that may be useful.

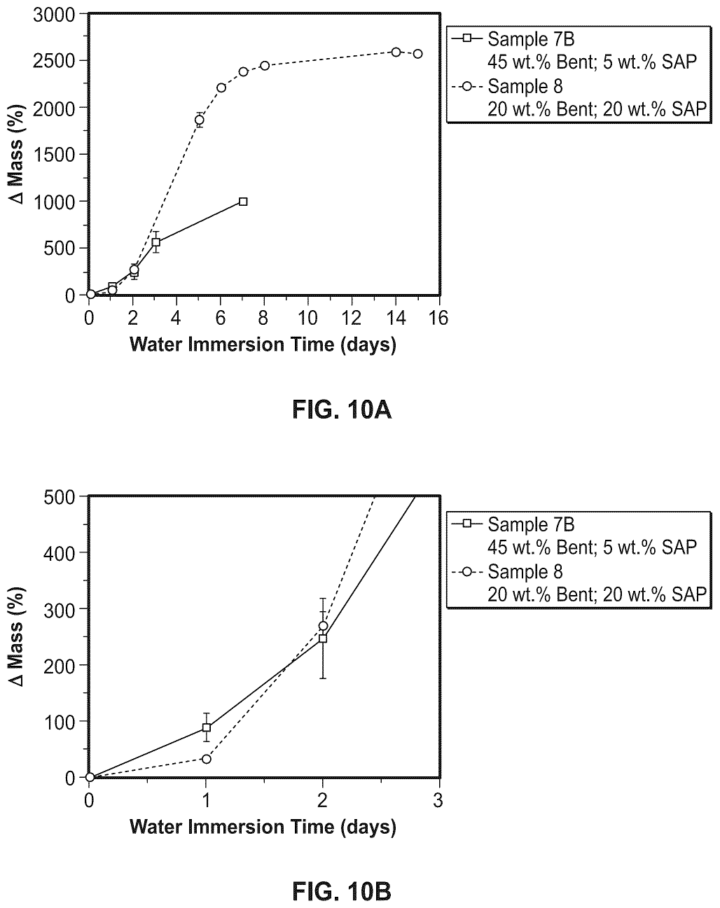

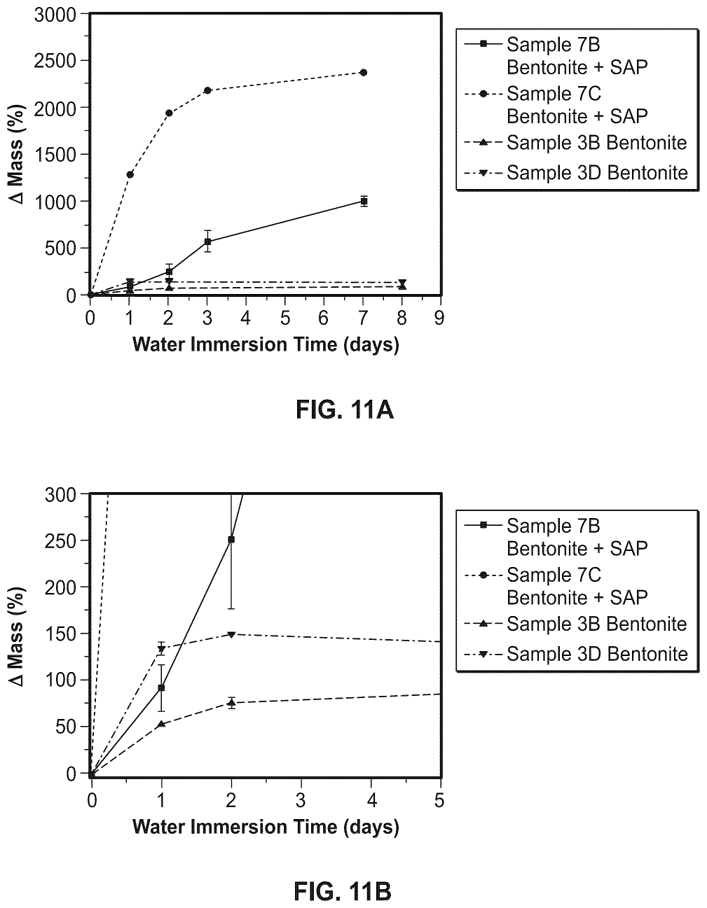

In an embodiment, the waterproofing composition can have a particular STᵢ that may provide improved performance and/or manufacturing of the waterproofing composition. STᵢ measures swell timing of compositions with delayed swelling. It specifically refers to the time it takes for a particular composition to reach an inflection point in a swelling over time plot (see FIGS. 10A and 11A). More details about methods of measuring STᵢ can be found in the examples. In an embodiment, the waterproofing composition can have an STᵢ of at least 0.1 days or 0.25 days 0.5 days or 1 day or 1.5 days or 2 days. In an embodiment, the waterproofing composition can have an STᵢ of no greater than 50 days or no greater than 40 days or no greater than 30 days or no greater than 20 days or no greater than 10 days or no greater than 9 days or no greater than 8 days or no greater than 7 days or no greater than 6 days or no greater than 5 days or no greater than 4 days or no greater than 3 days or no greater than 2 days or no greater than 1 day. It will be appreciated that the STᵢ of the waterproofing composition may be between any of the minimum and maximum values noted above, including for example, but not limited to, at least 0.5 days and no greater than 2 days or at least 1 day and no greater than 4 days or at least 2 days and no greater than 30 days or at least 2 days and no greater than 50 days.

In an embodiment, the waterproofing composition can have a particular ST₁₀₀ that may provide improved performance and/or manufacturing of the waterproofing composition. ST₁₀₀ measures swell timing of compositions with delayed swelling. It specifically refers to the time it takes for a particular composition to increase in by 100% mass based on the mass of the swellable filler in the composition in a swelling over time plot (see FIGS. 10A and 11A). More details about methods of measuring ST₁₀₀ can be found in the examples. In an embodiment, the waterproofing composition can have an ST₁₀₀ of at least 0.1 days or 0.25 days or 0.5 days or 1 day or 1.5 days or 2 days. In an embodiment, the waterproofing composition can have an ST₁₀₀ of no greater than no greater than 50 days or no greater than 40 days or no greater than 30 days or no greater than 20 days or no greater than 10 days or no greater than 9 days or no greater than 8 days or no greater than 7 days or no greater than 6 days or no greater than 5 days or no greater than 4 days or no greater than 3 days or no greater than 2 days or no greater than 1 day. It will be appreciated that the ST₁₀₀ of the waterproofing composition may be between any of the minimum and maximum values noted above, including for example, but not limited to, least 0.5 days and no greater than 2 days or at least 1 day and no greater than 4 days or at least 2 days and no greater than 30 days or at least 2 days and no greater than 50 days.

In an embodiment, the waterproofing composition can have a particular ST_{1/2} that may provide improved performance and/or manufacturing of the waterproofing composition. ST₁ measures swell timing of compositions with delayed swelling. It specifically refers to the time it takes for a particular composition swell to half of the maximum swelling in a swelling over time plot (see FIGS. 10A and 11A). More details about methods of measuring ST_{1/2} can be found in the examples. In an embodiment, the waterproofing composition can have an ST_{1/2} of at least 0.1 days or 0.25 days 0.5 days or 1 day or 1.5 days or 2 days. In an embodiment, the waterproofing composition can have an ST_{1/2} of no greater than 50 days or no greater than 40 days or no greater than 30 days or no greater than 20 days or no greater than 10 days or no greater than 9 days or no greater than 8 days or no greater than 7 days or no greater than 6 days or no greater than 5 days or no greater than 4 days or no greater than 3 days or no greater than 2 days or no greater than 1 day. It will be appreciated that the ST_{1/2} of the waterproofing composition may be between any of the minimum and maximum values noted above, including for example, but not limited to, least 0.5 days and no greater than 2 days or at least 1 day and no greater than 4 days or at least 2 days and no greater than 30 days or at least 2 days and no greater than 50 days.

In an aspect, the waterproofing composition comprises the hydrophobic binder as disclosed herein and a swellable filler comprising swellable clay of the present disclosure present in an amount of at least 25 wt. % swellable clay and not greater than 70 wt. % swellable clay or at least 30 wt. % swellable clay and not greater than 65 wt. % swellable clay or at least 35 wt. % swellable clay and not greater than 60 wt. % swellable clay. Alternatively, the difference between the concentration of swellable filler and the critical filler concentration C_{f} may be no greater than 20 wt. % or no greater than 18 wt. % or no greater than 16 wt. % or no greater than 14 wt. % or no greater than 12 wt. % or no greater than 10 wt. % or no greater than 8 wt. % or no greater than 6 wt. % or no greater than 5 wt. %, based on the total weight of the composition, The waterproofing composition can be substantially free of super absorbent polymer. The waterproofing composition can have a maximum swellability of at least 30 wt. % and no greater than 300 wt. % or at least 35 wt. % and no greater than 280 wt. % or at least 40 wt. % and no greater than 250 wt. %.

In yet another aspect, the waterproofing composition comprises the hydrophobic binder as disclosed herein and a swellable filler. The swellable filler can include a combination of swellable clay and super absorbent polymer. The waterproofing composition can include at least 5 wt. % super absorbent polymer and not greater than 25 wt. % super absorbent polymer or at least 10 wt. % super absorbent polymer and not greater than 50 wt. % super absorbent polymer or 15 wt. % super absorbent polymer and not greater than 25 wt. % super absorbent polymer or 12 wt. % super absorbent polymer and not greater than 22 wt. % super absorbent polymer %, where the amounts in wt. % are based on the total weight of the waterproofing composition. The waterproofing composition can include a swellable clay of the present disclosure present in an amount in the range of at least 25 wt. % swellable clay and not greater than 70 wt. % swellable clay or at least 30 wt. % swellable clay and not greater than 65 wt. % swellable clay or at least 35 wt. % swellable clay and not greater than 60 wt. % swellable clay. The waterproofing composition can include a total swellable filler content of at least 15 wt. % total swellable filler and not greater than 85 wt. % total swellable filler or at least 30 wt. % total swellable filler and not greater than 50 wt. % total swellable filler or at least 15 wt. % total swellable filler and not greater than 40 wt. % total swellable filler or at least 15 wt. % total swellable filler and not greater than 50 wt. % total swellable filler, The hydrophobic binder can be a stiff polymer modified asphalt binder. In an embodiment, the waterproofing composition can have an STᵢ of least 0.5 days and no greater than 2 days or at least 1 day and no greater than 4 days or at least 2 days and no greater than 30 days or at least 2 days and no greater than 50 days. The waterproofing composition can have an ST₁₀₀ of least 0.5 days and no greater than 2 days or at least 1 day and no greater than 4 days or at least 2 days and no greater than 30 days or at least 2 days and no greater than 50 days. The waterproofing composition can have an ST_{1/2} of least 0.5 days and no greater than 2 days or at least 1 day and no greater than 4 days or at least 2 days and no greater than 30 days or at least 2 days and no greater than 50 days.

In an aspect, the waterproofing composition comprises the hydrophobic binder as disclosed herein and a super absorbent polymer as disclosed herein. The waterproofing composition can include at least 5 wt. % super absorbent polymer and not greater than 25 wt. % super absorbent polymer or at least 10 wt. % super absorbent polymer and not greater than 50 wt. % super absorbent polymer or 15 wt. % super absorbent polymer and not greater than 25 wt. % super absorbent polymer or 12 wt. % super absorbent polymer and not greater than 22 wt. % super absorbent polymer %, where the amounts in wt. % are based on the total weight of the waterproofing composition. The waterproofing composition can further include an inert filler. The inert filler may be an inert filler that does not contain multivalent cations. Alternatively, the inert filler may be an inert filler that has a dissociation constant, K, of less than 10-11. Alternatively, the fillers, both swellable and inert comprise a combination of at least one multivalent cationic salt and at least one monovalent cationic salt. Such compositions exhibit little to no deswelling.

In an aspect, the waterproofing composition comprises the hydrophobic binder as disclosed herein and a swellable filler. The waterproofing composition can have a total filler concentration of at least 25 wt. % or at least or 30 wt. % or at least 35 wt. % filler based on a total weight of the composition. Alternatively, the difference between the concentration of total filler and the critical filler concentration C_{f} may be no greater than 20 wt. % or no greater than 18 wt. % or no greater than 16 wt. % or no greater than 14 wt. % or no greater than 12 wt. % or no greater than 10 wt. % or no greater than 8 wt. % or no greater than 6 wt. % or no greater than 5 wt. %. The waterproofing composition can have a swelling consistency factor of no greater than 400% or no greater than 350% or no greater than 300% or no greater than 250% or no greater than 200% or no greater than 150%.

### Methods of Making Waterproofing Compositions

In an embodiment, a method of making a waterproofing composition can comprise mixing a hydrophobic binder as disclosed hereinabove with a swellable filler as disclosed hereinabove to form a waterproofing composition. The waterproofing composition can have any of the compositions, properties, or other elements described in the “waterproofing composition” sections above.

The method can further include mixing asphalt with a polymer additive to form the hydrophobic binder. This step can further include mixing a rheology modifier, or other additives described in the “waterproofing composition” sections above.

### Waterproofing Articles

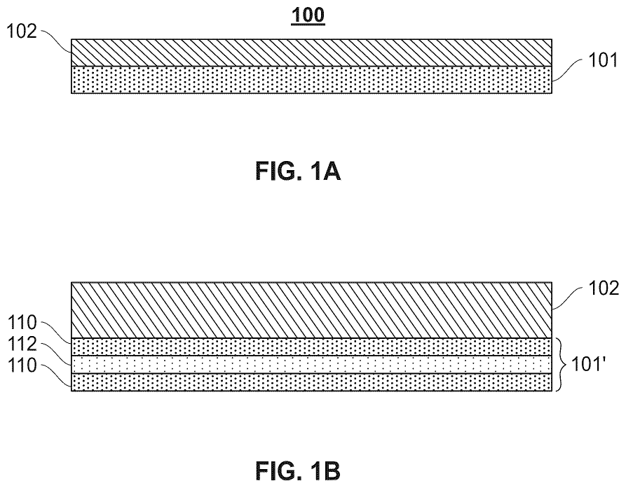

In an aspect, there is a waterproofing article 100, as shown in FIG. 1A. The waterproofing article can include a first swellable layer 101 comprising or consisting of any of the aforementioned waterproofing compositions, and a reinforcing layer 102 disposed in contact with the first swellable layer. The waterproofing article can have a front side, configured to adhere or attach to pre-cast concrete, and a rear side, configured to face soil or a water table. In alternative embodiments, the rear side of the membrane can be configured to adhere or attach to pre-cast concrete. In other alternative embodiments, the membrane can be applied to pre-cast concrete (fresh cast or fully cured concrete) or shotcrete. Embodiments may be adhered to or attached to pre-cast concrete or shotcrete with or without primer.

In other embodiments of the waterproofing article 100, the first swellable layer 101′ can include a sublayer comprising swellable filler 112 sandwiched between two sublayers of the hydrophobic binder 110, as schematically shown in FIG. 1B, such that at least one of the hydrophobic layer is in contact with the reinforcing layer 102.

The first swellable layer 101 may be towards the rear side of the article relative to the reinforcing layer. The reinforcing layer 102 may have a particular composition that may facilitate improved performance and/or manufacturing of the waterproofing article 200. In an embodiment, the reinforcing layer 102 can include PET mesh; a glass mat; a woven or non-woven fabric comprising acrylic acid or acrylate homo or copolymer, polyvinyl chloride (PVC), polyethylene terephthalate (PET), neoprene, nylon, polyurethane, or a combination thereof; or a combination thereof. In an embodiment, the reinforcing layer 102 includes an asphalt coated woven or non-woven fabric. In another embodiment, the reinforcing layer 202 includes asphalt coated PET mesh. In yet another embodiment, the reinforcing layer 202 includes asphalt coated glass fiber. In an embodiment, the areal density of the reinforcing layer can be at least 0.01 lbs/sq ft. or at least 0.02 lbs/sq ft. or at least 0.03 lbs/sq ft. or at least 0.04 lbs/sq ft. or at least 0.05 lbs/sq ft. In an embodiment the coating density of the reinforcing layer can be no greater than 1 lbs/sq ft. or no greater than 0.9 lbs/sq ft. or no greater than 0.8 lbs/sq ft. or no greater than 0.7 lbs/sq ft. or no greater than 0.6 lbs/sq ft. or no greater than 0.5 lbs/sq ft. or no greater than 0.4 lbs/sq ft. or no greater than 0.3 lbs/sq ft. or no greater than 0.2 lbs/sq ft. In an embodiment the coating density of the reinforcing layer 202 can be in the range of 0.05 lbs/sq ft. to 1 lbs/sq ft. or 0.03 lbs/sq ft. to than 0.7 lbs/sq ft. or 0.01 lbs/sq ft. to 0.2 lbs/sq ft.

In an embodiment, the swellable layer may have a particular coating density that may provide improved performance and/or manufacturing of the waterproofing article. In an embodiment, the coating density of the swellable layer can be at least 0.05 lbs/sq ft. or at least 0.06 lbs/sq ft. or at least 0.07 lbs/sq ft. or at least 0.08 lbs/sq ft. or at least 0.09 lbs/sq ft. or at least 0.1 lbs/sq ft. In an embodiment the coating density of the swellable layer can be no greater than 1 lbs/sq ft. or no greater than 0.9 lbs/sq ft. or no greater than 0.8 lbs/sq ft. or no greater than 0.7 lbs/sq ft. or no greater than 0.6 lbs/sq ft. or no greater than 0.5 lbs/sq ft. or no greater than 0.4 lbs/sq ft. or no greater than 0.3 lbs/sq ft. or no greater than 0.2 lbs/sq ft. In an embodiment the coating density of the swellable layer 201 can be in the range of 0.05 lbs/sq ft. to 1 lbs/sq ft. or 0.07 lbs/sq ft. to than 0.7 lbs/sq ft. or 0.1 lbs/sq ft. to 0.2 lbs/sq ft.

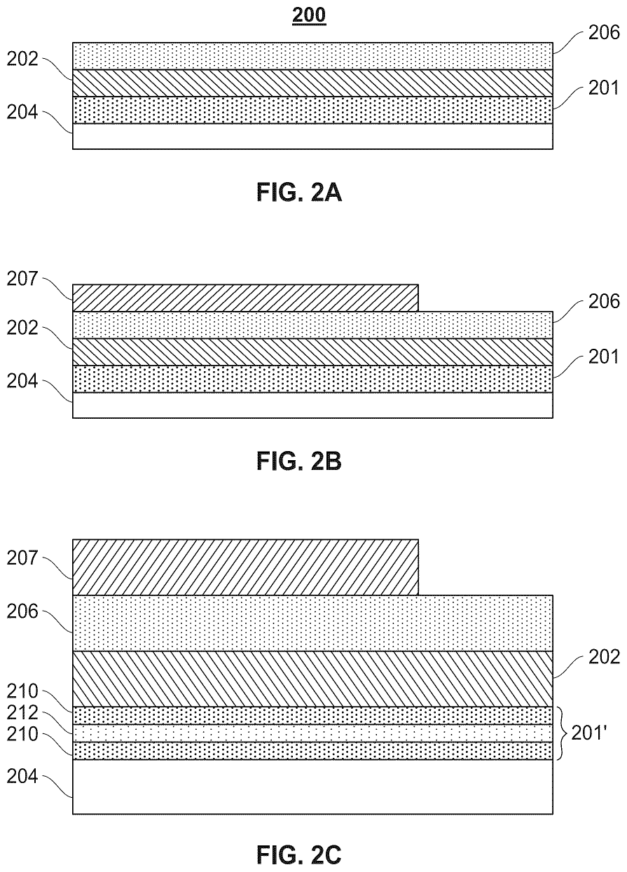

In an aspect, the waterproofing article 200 can further include a backing layer 204 disposed over the first swellable layer, opposite the reinforcing layer, as shown in FIGS. 2A 2B and 2C. The backing layer 204 can form the rear side of the waterproofing article 200. The backing layer may have a particular composition that may facilitate improved performance and/or manufacturing of the waterproofing article 200. In an embodiment, the backing layer 204 can include a film, a woven or nonwoven mat, inorganic or organic fibers, fiberglass, ceramic fibers, polymer fibers, polyester fibers, polyolefin fibers, granules, sand, a swellable clay, or a combination thereof.

In an embodiment, the backing layer 204 may have a particular coating density that may provide improved performance and/or manufacturing of the waterproofing article. In an embodiment, the coating density of the backing layer 204 can be at least 0.01 lbs/sq ft. or at least 0.02 lbs/sq ft. or at least 0.03 lbs/sq ft. or at least 0.04 lbs/sq ft. or at least 0.05 lbs/sq ft. In an embodiment the coating density of the backing can be no greater than 0.6 lbs/sq ft. or no greater than 0.5 lbs/sq ft. or no greater than 0.4 lbs/sq ft. In an embodiment the coating density of the backing layer 204 can be in the range of 0.01 lbs/sq ft. to 0.6 lbs/sq ft., or 0.03 lbs/sq ft. or to 0.5 lbs/sq ft., or 0.05 lbs/sq ft. to 0.4 lbs/sq ft.

In an embodiment, the waterproofing article 200 can include a second functional layer 206 disposed over the reinforcing layer 202, opposite the swellable layer 201. The second functional layer 206 forms the front side of the waterproofing article. In various embodiments, the second functional layer 206 comprises a second hydrophobic binder and an optional swellable filler or inert filler. In some embodiments second functional layer 206 can be configured to swell in contact with water like the swellable layer 201. In such embodiments, the second functional layer may have the same composition, structure and properties as the swellable layer 201. Such embodiments can include the features described hereinabove with regard to the swellable layer 201.

In various embodiments, the second functional layer 206 can have a composition, structure, and properties different from that of the swellable layer 201, such that the second functional layer 206 substantially does not swell when in contact with water. In other embodiments, the second functional layer 206 can be configured to substantially not swell when in contact with water and adhere to pre or post cast concrete or shotcrete. In some embodiments, the second functional layer can be configured to swell in contact with water and to adhere to pre or post cast concrete or shotcrete.

In an embodiment, the second functional layer 206 can include a particular asphalt content that may facilitate improved performance and/or manufacturing of the waterproofing article. In an embodiment the second functional layer 206 can include at least 5 wt. % asphalt or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % asphalt based on a total weight of the waterproofing composition. In an embodiment, the second functional layer 206 may include no greater than 99 wt. % asphalt or no greater than 95 wt. % or no greater than 90 wt. % or no greater than 85 wt. % or no greater than 80 wt. % or no greater than 75 wt. % or no greater than 70 wt. % or no greater than 65 wt. % or no greater than 60 wt. % or no greater than 55 wt. % or no greater than 50 wt. % or no greater than 45 wt. % or no greater than 40 wt. % or no greater than 35 wt. % or no greater than 30 wt. % or no greater than 25 wt. % or no greater than 20 wt. % or no greater than 15 wt. % or no greater than 10 wt. % asphalt based on a total weight of the waterproofing composition. It will be appreciated that the asphalt content of the waterproofing composition may be between any of the minimum and maximum values noted above, including for example, but not limited to, at least 5 wt. % asphalt and not greater than 90 wt. % asphalt or at least 45 wt. % asphalt and not greater than 70 wt. % asphalt or at least 30 wt. % and not greater than 80 wt. %, based on a total weight of the waterproofing composition.

In an embodiment, the second functional layer 206 may have a particular coating density that may provide improved performance and/or manufacturing of the waterproofing article. In an embodiment, the coating density of the second functional layer 206 can be least 0.01 lbs/sq ft. or at least 0.02 lbs/sq ft. or at least 0.03 lbs/sq ft. or at least 0.04 lbs/sq ft. or at least 0.05 lbs/sq ft. or at least 0.06 lbs/sq ft. or at least 0.07 lbs/sq ft. or at least 0.08 lbs/sq ft. or at least 0.09 lbs/sq ft. or at least 0.10 lbs/sq ft. or at least 0.11 lbs/sq ft. or at least 0.12 lbs/sq ft. or at least 0.13 lbs/sq ft. or at least 0.14 lbs/sq ft. or at least 0.15 lbs/sq ft. or at least 0.16 lbs/sq ft. or at least 0.17 lbs/sq ft. or at least 0.18 lbs/sq ft. or at least 0.19 lbs/sq ft. or at least 0.2 lbs/sq ft. In an embodiment the coating density of the second functional layer 206 can be no greater than 1 lbs/sq ft. or no greater than 0.9 lbs/sq ft. or no greater than 0.8 lbs/sq ft. or no greater than 0.7 lbs/sq ft. or no greater than 0.6 lbs/sq ft. or no greater than 0.5 lbs/sq ft. or no greater than 0.4 lbs/sq ft. In an embodiment the coating density of the second functional layer 206 can be in the range of 0.01 lbs/sq ft. to 1 lbs/sq ft. or 0.10 lbs/sq ft. to 0.8 lbs/sq ft. or 0.2 lbs/sq ft. to 0.4 lbs/sq ft.

In an embodiment, the waterproofing article 200 may have a particular adhesion to pre or post cast concrete or shotcrete that may facilitate improved performance of the waterproofing article 200. In an embodiment, the second functional layer 206 can have an adhesion to concrete or shotcrete of at least 2 pli or at least 3 pli or at least 4 pli or at least 5 pli. In an alternative embodiment, the second functional layer 206 can have an adhesion to concrete or shotcrete of no greater than 50 or no greater than 45 or no greater than 40 or no greater than 35 or no greater than 30 or no greater than 25 or no greater than 20 pli or no greater than 19 pli or no greater than 18 pli or no greater than 17 pli or no greater than 16 pli or no greater than 15 pli. It will be appreciated that the adhesion of the second functional layer 206 may be between any of the minimum and maximum values noted above.

In an embodiment, the waterproofing article 200 may further include a particulate layer 207 disposed over at least a portion of the second functional layer 206, as shown in FIG. 2B. In an embodiment, the particulate layer 207 includes a particulate material embedded in a surface of the second functional layer 206. In embodiments, the particulate materials may be at least partially embedded in and partially protruding from a top surface of the second functional layer 206. The particulate material can include granules, sand, a swellable clay, cement, hydrated cement, limestone, slag fly ash or a combination thereof. The particulate materials may further include a functional coating. The particulate material can have a median particle size of at least 10 microns and no greater than 5000 microns or at least 100 microns and no greater than 1000 microns. Particle sizes of particulate materials may be measured with light scattering using 405 and 650 nm light source with a Horiba LA-950v2 detector.

In an embodiment, the particulate material may have a particular coating density that may provide improved performance and/or manufacturing of the waterproofing article. In an embodiment, the coating density of the particulate material can be at least 0.01 lbs/sq ft. or at least 0.02 lbs/sq ft. or at least 0.03 lbs/sq ft. or at least 0.04 lbs/sq ft. or at least 0.05 lbs/sq ft. In an embodiment the coating density of the particulate material can be no greater than 0.6 lbs/sq ft. or no greater than 0.5 lbs/sq ft. or no greater than 0.4 lbs/sq ft. In an embodiment the coating density of the particulate material can be in the range of 0.01 lbs/sq ft. to 0.6 lbs/sq ft., or 0.03 lbs/sq ft. or to 0.5 lbs/sq ft., or 0.05 lbs/sq ft. to 0.4 lbs/sq ft.

In an embodiment, a top surface 208 of the front side of the waterproofing article 200 may have a particular reflectivity that may facilitate improved performance and/or manufacturing of the waterproofing article. In an embodiment, the top surface of the may have a reflectivity of at least 5% or at least 10% or at least 15% or at least 20% or at least 25% or at least 30% or at least 35% or at least 40% or at least 5% or at least 50% or at least 55% or at least 60% or at least 65% or at least 70% or at least 75% or at least 80% or at least 85% or at least 90% or at least 95%. In an embodiment, the top surface may have a reflectivity of not greater than 95% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10% or not greater than 5%. It will be appreciated that the reflectivity may be between any of the minimum and maximum values noted above, including for example, but not limited to, at least 5% and not greater than 95% or at least 15% and not greater than 50%.

Reflectivity can be measured with a NOVO-SHADE 45/0 Reflectometer. The test surface is illuminated from a 45° angle and the intensity of scattered light at the perpendicular (i.e., 0°) is measured. Data is recorded on a grey scale where black is 0% and white is 100%. Only shading is measured, irrespective of color, and is referred to as % whiteness.

In an embodiment, the waterproofing article 200 can include a polymeric layer (not shown) disposed over a portion of the second functional layer 206 or over a portion of the backing 204, such that the polymeric layer is configured as a release film, a burn-off film, a sacrificial film or a combination thereof. The polymeric layer may include a woven fabric, a nonwoven fabric, a polymer film, or a combination thereof. The polymeric layer may comprise polyethylene such as high density polyethylene (HDPE), polypropylene (PP), or acrylic. The polymeric layer may have any suitable thickness, such as in the range of 2 microns to 50 microns or 5 microns to 40 microns, or 10 microns to 30 microns.

In an aspect, there is a waterproofing membrane comprising:
(i) a backing layer disposed over at least a portion of a first functional layer;
(ii) a reinforcing layer overlying the first functional layer, opposite the backing layer;
(iii) a second functional layer disposed over the reinforcing layer on a side opposite the first functional layer;
(iv) a particulate layer disposed over on at least a portion of the second functional layer, wherein the particulate layer includes a particulate material embedded in a surface of the second functional layer; and
(v) an optional polymeric layer disposed over at least a portion of the second functional layer and or the first functional layer, on a side opposite the reinforcing layer.

In an embodiment of the waterproofing membrane, the first functional layer comprises the hydrophobic binder, as disclosed hereinabove, and one of the following:
(i) a swellable filler consisting of swellable clay, as disclosed hereinabove, present in an amount in the range of at least 25 wt. % swellable clay and not greater than 70 wt. % swellable clay or at least 30 wt. % swellable clay and not greater than 65 wt. % swellable clay or at least 35 wt. % swellable clay and not greater than 60 wt. % swellable clay, such that the swellable filler is substantially free of super absorbent polymer. The waterproofing composition having swellability of at least 30 wt. % and no greater than 300 wt. % or at least 35 wt. % and no greater than 280 wt. % or at least 40 wt. % and no greater than 250 wt. %
(ii) a swellable filler consisting of a super absorbent polymer of the present disclosure present in an amount in the range and an optional inert filler, as disclosed hereinabove, the total filler content being in an amount in the range of at least 25 wt. % or at least or 30 wt. % or at least 35 wt. % filler based on a total weight of the composition. The waterproofing composition having a swelling consistency of no greater than 20 wt. % or no greater than 18 wt. % or no greater than 16 wt. % or no greater than 14 wt. % or no greater than 12 wt. % or no greater than 10 wt. % or no greater than 8 wt. % or no greater than 6 wt. % or no greater than 5 wt. %.
(iii) a swellable filler comprising a super absorbent polymer present in an amount in the range of 5 wt. % and not greater than 25 wt. % or at least 10 wt. % and not greater than 50 wt. % or 15 wt. % and not greater than 25 wt. % or 12 wt. % and not greater than 22 wt. % and a swellable clay present in an amount in the range of at least 25 wt. % swellable clay and not greater than 70 wt. % swellable clay or at least 30 wt. % swellable clay and not greater than 65 wt. % swellable clay or at least 35 wt. % swellable clay and not greater than 60 wt. % swellable clay. The hydrophobic binder can be a stiff polymer modified asphalt binder. The waterproofing composition has an STᵢ of least 0.5 days and no greater than 2 days or at least 1 day and no greater than 4 days or at least 2 days and no greater than 30 days or at least 2 days and no greater than 50 days or an ST₁₀₀ of least 0.5 days and no greater than 2 days or at least 1 day and no greater than 4 days or at least 2 days and no greater than 30 days or at least 2 days and no greater than 50 days. The waterproofing composition can have an ST_{1/2} of least 0.5 days and no greater than 2 days or at least 1 day and no greater than 4 days or at least 2 days and no greater than 30 days or at least 2 days and no greater than 50 days.
(iv) a swellable filler comprising a super absorbent polymer present in an amount in the range of 5 wt. % and not greater than 25 wt. % or at least 10 wt. % and not greater than 50 wt. % or 15 wt. % and not greater than 25 wt. % or 12 wt. % and not greater than 22 wt. % as well as an inert filler. The inert filler may be an inert filler that does not contain multivalent cations. Alternatively, the inert filler may be an inert filler that has a dissociation constant, K, of less than 10-11. Alternatively, the fillers, both swellable and inert comprise a combination of at least one multivalent cationic salt and at least one monovalent cationic salt.

In an embodiment of the waterproofing membrane, the first functional layer further comprises an inert filler as disclosed hereinabove. In another embodiment, the hydrophobic binder present in the first or the second functional layer is a soft hydrophobic binder. In yet another embodiment, the hydrophobic binder present in the first or the second functional layer is a stiff hydrophobic binder. In yet another embodiment, the hydrophobic binder present in the first or the second functional layer is a polymer modified asphalt. In another embodiment, the second functional layer comprises a polymer modified asphalt and an optional inert filler.

### Method of Making a Waterproofing Article

In an embodiment, a method of making a waterproofing article comprises:
forming a first functional layer by depositing a waterproofing composition, as disclosed hereinabove, onto a reinforcing layer or by depositing a swellable filler sandwiched between two layers of hydrophobic binders onto a reinforcing layer,
the waterproofing composition comprising a hydrophobic binder, the hydrophobic binder comprising at least one of the following:
   a polymer modified asphalt comprising asphalt and a polymer additive;
   a hot melt adhesive; and
   a thermoplastic polymer;
and a swellable filler comprising at least one of the following:
   at least 15 wt. % and no greater than 85 wt. % of a swellable clay, and at least 0.1 wt. % and no greater than 70 wt. % of a super absorbent polymer;
wherein the amounts in wt. % are based on a total weight of the waterproofing composition.

In an embodiment, the substrate can be a reinforcing layer according to the reinforcing layers described in the above “Waterproofing Article” section or the embodiments below.

In an embodiment, the step of depositing a waterproofing composition sandwiched between two layers of hydrophobic binders comprises first depositing a first layer of hydrophobic binder over the reinforcing layer, followed by disposing a layer of swellable filler as disclosed hereinabove over the first layer of the hydrophobic binder, and followed by depositing another layer of hydrophobic binder over the layer of swellable filler to form the first functional layer.

In an embodiment, the method can further include depositing a backing over the first functional layer. The backing can be as described the above “Waterproofing Article” section or the embodiments below.

In an embodiment, the method can further include depositing a second functional layer onto the reinforcing layer opposite the swellable layer. The second functional layer can be a second functional layer as described the above “Waterproofing Article” section or the embodiments below.

In an embodiment, the method can further include depositing a particulate material onto at least a portion of the second functional layer. The particulate material can be a particulate material as described the above “Waterproofing Article” section or the embodiments below.

### Method of Applying a Waterproofing Article

In an embodiment, a method of waterproofing a concrete structure comprises applying a waterproofing article as described hereinabove to a building substrate or concrete form with the releasable material of said membrane facing the area into which the concrete will be cast, and casting concrete such that the concrete contacts the releasable material of the membrane. Alternatively, shotcrete may be used in place of concrete.

In an alternative embodiment, a method of waterproofing a concrete structure comprises applying a waterproofing article as described hereinabove to already cast concrete. Alternatively, shotcrete may be used in place of concrete.

### EMBODIMENTS

Embodiment 1. A waterproofing composition comprising:
a hydrophobic binder, the hydrophobic binder comprising at least one of the following:
   1) A polymer modified asphalt comprising asphalt and a polymer additive;
   2) A hot melt adhesive;
   3) A thermoplastic polymer
and
a swellable filler comprising at least one of the following:
(i) at least 15 wt. % and no greater than 85 wt. % of a swellable clay, and
(ii) at least 0.1 wt. % and no greater than 70 wt. % of a super absorbent polymer;
   wherein the amounts in wt. % are based on a total weight of the waterproofing composition.

Embodiment 2. The waterproofing composition of embodiment 1, wherein the hydrophobic binder comprises a polymer modified asphalt.

Embodiment 3. The waterproofing composition of embodiment 2, wherein the hydrophobic binder has a viscosity of at least 1200 cps at 375° F.

Embodiment 4. The waterproofing composition of embodiment 2, wherein the hydrophobic binder has a viscosity of no greater than 1200 cps at 375° F.

Embodiment 5. The waterproofing composition of embodiment 2, wherein the waterproofing composition comprises at least 5 wt. % asphalt or at least 10 wt. % or at least 15 wt. % or at least 20 wt. % or at least 25 wt. % or at least 30 wt. % or at least 35 wt. % or at least 40 wt. % or at least 45 wt. % or at least 50 wt. % or at least 55 wt. % or at least 60 wt. % or at least 65 wt. % or at least 70 wt. % or at least 75 wt. % or at least 80 wt. % or at least 85 wt. % or at least 90 wt. % asphalt for a total weight of the waterproofing composition.

Embodiment 6. The waterproofing composition of embodiment 2, wherein the waterproofing composition comprises no greater than 99 wt. % asphalt or no greater than 95 wt. % or no greater than 90 wt. % or no greater than 85 wt. % or no greater than 80 wt. % or no greater than 75 wt. % or no greater than 70 wt. % or no greater than 65 wt. % or no greater than 60 wt. % or no greater than 55 wt. % or no greater than 50 wt. % or no greater than 45 wt. % or no greater than 40 wt. % or no greater than 35 wt. % or no greater than 30 wt. % or no greater than 25 wt. % or no greater than 20 wt. % or no greater than 15 wt. % or no greater than 10 wt. % asphalt for a total weight of the waterproofing composition.

Embodiment 7. The waterproofing composition of embodiment 1, wherein the waterproofing composition comprises a swelling percentage of at least of at least 25% or at least 30% or at least 35% or at least 40% or at least 45% or at least 50% or at least 55% or at least 60% or at least 65% or at least 70% or at least 75% or at least 80% or at least 85% or at least 90% or at least 95% or at least 100% or at least 110% or at least 120% or at least 130% or at least 140% or at least 150% or at least 160% or at least 170% or at least 180% or at least 190% or at least 200% or at least 210% or at least 220% or at least 230% or at least 240% or at least 250% or at least 300% or at least 350% or at least 400% or at least 450% or at least 500% or at least 550% or at least 600% or at least 750% or at least 800% or at least 850% or at least 1000%.

Embodiment 8. The waterproofing composition of embodiment 1, wherein the waterproofing composition comprises a maximum swelling percentage of no greater than 10000% or no greater than 9500% or no greater than 9000% or no greater than 8500% or no greater than 8000% or no greater than 7500% or no greater than 7000% or no greater than 6500% or no greater than 6000% or no greater than 5500% or no greater than 5000% or no greater than 4500% or no greater than 4000% or no greater than 3500% or no greater than 3000% or no greater than 2500% or no greater than 2000% or no greater than 1500% or no greater than 1000% or no greater than 500% or no greater than 400% or no greater than 300% or no greater than 290% or no greater than 280% or no greater than 270% or no greater than 260% or no greater than 250%.

Embodiment 9. The waterproofing composition of embodiment 1, wherein the swellable filler comprises a swellable clay, a super absorbent polymer, or a combination thereof.

Embodiment 10. The waterproofing composition of embodiment 9, wherein the swellable filler comprises a swellable clay and a super absorbent polymer.

Embodiment 11. The waterproofing composition of any one of embodiments 9 or 10, wherein the super absorbent polymer comprises a polyacrylate copolymer, a polyacrylamide copolymer, a polyvinyl alcohol copolymer, polyethylene oxide copolymer, a maleic anhydride copolymer, a cellulose graft copolymer, a starch acrylonitrile graft copolymer or a combination thereof.

Embodiment 12. The waterproofing composition of any one of embodiments 9 or 10, wherein the super absorbent polymer comprises a polyacrylate copolymer.

Embodiment 13. The waterproofing composition of any one of embodiments 9 or 10, wherein the super absorbent polymer comprises a crosslinked sodium polyacrylate.

Embodiment 14. The waterproofing composition of any one of embodiments 9 or 10, wherein the waterproofing composition comprises at least 0.1 wt. % super absorbent polymer or at least 0.5 wt. % or at least 1 wt. % or at least 1.5 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % super absorbent polymer for a total weight of the waterproofing composition.

Embodiment 15. The waterproofing composition of any one of embodiments 9 or 10, wherein the waterproofing composition comprises no greater than no greater than 70 wt. % or no greater than 65 wt. % or no greater than 60 wt. % or no greater than 55 wt. % or no greater than 50 wt. % or no greater than 45 wt. % or no greater than 40 wt. % or no greater than 35 wt. % or no greater than 30 wt. % or no greater than 25 wt. % or no greater than 20 wt. % or no greater than 15 wt. % or no greater than wt. % or no greater than 10 wt. %.

Embodiment 16. The waterproofing composition of any one of embodiments 9 or 10, wherein the super absorbent polymer comprises a mean particle of 10 to 1000 microns, or 20 to 400 microns, or 50 to 200 microns.

Embodiment 17. The waterproofing composition of any one of embodiments 9 or 10, wherein the swellable clay comprises smectite, bentonite, vermiculite, montmorillonite, nontronite, saponite, or combinations thereof.

Embodiment 18. The waterproofing composition of any one of embodiments 9 or 10, wherein the swellable clay comprises smectite or bentonite.

Embodiment 19. The waterproofing composition of embodiment 18, wherein the smectite or bentonite comprises a bentonite salt.

Embodiment 20. The waterproofing composition of embodiment 19, wherein the bentonite salt comprises sodium bentonite, potassium bentonite, calcium bentonite, magnesium bentonite, aluminum bentonite, or a combination thereof.

Embodiment 21. The waterproofing composition of embodiment 19, wherein the bentonite salt comprises sodium bentonite.

Embodiment 22. The waterproofing composition of any one of embodiments 9 or 10, wherein the swellable clay comprises a mean particle size of 10 to 2000 microns, or 20 to 1000 microns or 50 to 200 microns.

Embodiment 23. The waterproofing composition of any one of embodiments 9 or 10, wherein the waterproofing composition comprises at least 16 wt. % swellable clay or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % swellable clay for a total weight of the waterproofing composition.

Embodiment 24. The waterproofing composition of any one of embodiments 9 or 10, wherein the waterproofing composition comprises no greater than 85 wt. % swellable clay or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 60 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. %.

Embodiment 25. The waterproofing composition of embodiment 1, wherein the waterproofing composition comprises at least 0.1 wt. % total swellable filler or at least 0.5 wt. % or at least 1 wt. % or at least 1.5 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % total swellable filler.

Embodiment 26. The waterproofing composition of embodiment 1, wherein the waterproofing composition comprises no greater than 85 wt. % total swellable filler or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 60 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 45 wt. % or no greater than 40 wt. % or no greater than 35 wt. % or no greater than 30 wt. % or no greater than 25 wt. % or no greater than 20 wt. % or no greater than 15 wt. % or no greater than wt. % or no greater than 10 wt. % total swellable filler.

Embodiment 27. The waterproofing composition of embodiment 1, wherein the polymer additive comprises an acrylic modifier, a tackifier, atactic polypropylene, isotactic polypropylene, ethylene vinylacetate, styrenic block copolymers, polyvinyl butyral, paraffinic oligomers, virgin or recycled rubbers, butyl rubber, polyolefin block copolymers, polymeric microspheres, or a combination thereof.

Embodiment 28. The waterproofing composition of embodiment 1, wherein the polymer additive comprises a styrenic block copolymer.

Embodiment 29. The waterproofing composition of embodiment 1, wherein the polymer additive comprises a styrene-butadiene-styrene rubber.

Embodiment 30. The waterproofing composition of embodiment 1, wherein the polymer additive comprises a radial styrene-butadiene-styrene rubber.

Embodiment 31. The waterproofing composition of any one of embodiments 27, 28, or 29, wherein the hydrophobic binder comprises a ratio of asphalt content:polymer additive content of at least 0.1:1 or at least 0.5:1 or at least 1:1 or at least 1.5:1 or at least 2:1 or at least 2.5:1 or at least 3:1 or at least 3.5:1 or at least 4:1 or at least 4.5:1 or at least 5:1 or at least 5.5:1 or at least 6:1 or at least 6.5:1 or at least 7:1 or at least 7.5:1 or at least 8:1 or at least 8.5:1 or at least 9:1.

Embodiment 32. The waterproofing composition of any one of embodiments 27, 28, or 29, wherein the hydrophobic binder comprises a ratio of asphalt content:polymer content of no greater than 100:1 or no greater than 90:1 or no greater than 80:1 or no greater than 70:1 or no greater than 60:1 or no greater than 50:1 or no greater than 40:1 or no greater than 30:1 or no greater than 20:1 or no greater than 15:1 or no greater than 12:1 or no greater than 10:1 or no greater than 5:1.

Embodiment 33. The waterproofing composition of any one of embodiments 27, 28, or 29, wherein the waterproofing composition comprises at least 1 wt. % polymer additive or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % polymer additive for a total weight of the waterproofing composition.

Embodiment 34. The waterproofing composition of any one of embodiments 27, 28, or 29, wherein the waterproofing composition comprises no greater than 85 wt. % polymer additive or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % filler or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % or no greater than 19 wt. % or no greater than 18 wt. % or no greater than 17 wt. % or no greater than 16 wt. % or no greater than 15 wt. % or no greater than 14 wt. % or no greater than 13 wt. % or no greater than 12 wt. % or no greater than 11 wt. % or no greater than 10 wt. % or no greater than 9 wt. % or no greater than 8 wt. % or no greater than 7 wt. % or no greater than 6 wt. % or no greater than 5 wt. % polymer additive for a total weight of the waterproofing composition.

Embodiment 35. The waterproofing composition of embodiment 1, wherein the hydrophobic further comprises a rheology modifier.

Embodiment 36. The waterproofing composition of embodiment 35, wherein the rheology modifier comprises process oil, paraffinic wax, castor wax, amide wax, a colloidal additive, a surface active agent, or a combination thereof.

Embodiment 37. The waterproofing composition of embodiment 35, wherein the rheology modifier comprises process oil.

Embodiment 38. The waterproofing composition of embodiment 37, wherein the process oil comprises an aromatic oil, a napthenic oil, a paraffinic oil or a combination thereof.

Embodiment 39. The waterproofing composition of embodiment 37, wherein the hydrophobic binder comprises a ratio of asphalt content:rheology modifier content of at least 0.1:1 or at least 0.5:1 or at least 1:1 or at least 1.5:1 or at least 2:1 or at least 2.5:1 or at least 3:1 or at least 3.5:1 or at least 4:1 or at least 4.5:1 or at least 5:1 or at least 5.5:1 or at least 6:1 or at least 6.5:1 or at least 7:1 or at least 7.5:1 or at least 8:1 or at least 8.5:1 or at least 9:1.

Embodiment 40. The waterproofing composition of embodiment 37, wherein the hydrophobic binder comprises a ratio of asphalt content:rheology modifier content no greater than 100:1 or no greater than 90:1 or no greater than 80:1 or no greater than 70:1 or no greater than 60:1 or no greater than 50:1 or no greater than 40:1 or no greater than 30:1 or no greater than 25:1 or no greater than 20:1 or no greater than 20:1 or no greater than 15:1 or no greater than 10:1 or no greater than 5:1.

Embodiment 41. The waterproofing composition of embodiment 37, wherein the waterproofing composition comprises at least 1 wt. % rheology modifier or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % rheology modifier for a total weight of the waterproofing composition.

Embodiment 42. The waterproofing composition of embodiment 37, wherein the waterproofing composition comprises no greater than 80 wt. % rheology modifier or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % rheology modifier or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % filler or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % or no greater than 19 wt. % or no greater than 18 wt. % or no greater than 17 wt. % or no greater than 16 wt. % or no greater than 15 wt. % or no greater than 14 wt. % or no greater than 13 wt. % or no greater than 12 wt. % or no greater than 11 wt. % or no greater than 10 wt. % or no greater than 9 wt. % or no greater than 8 wt. % or no greater than 7 wt. % or no greater than 6 wt. % or no greater than 5 wt. % rheology modifier for a total weight of the waterproofing composition. Embodiment 43. The waterproofing composition of embodiment 1, wherein the waterproofing composition comprises a viscosity at 375° F. of no greater than 1,500,000 cps or no greater than 1,000,000 cps or no greater than 500,000 cps or no greater than 100,000 cps or no greater than 90,000 cps or no greater than 80,000 cps or no greater than 70,000 cps or no greater than 60,000 cps or no greater than 50,000 cps or no greater than 40,000 cps or no greater than 30,000 cps or no greater than 20,000 cps or no greater than 10,000 cps.

Embodiment 44. The waterproofing composition of embodiment 1, wherein the waterproofing composition comprises a viscosity at 375° F. of at least 1 cps.

Embodiment 45. The waterproofing composition of embodiment 1, wherein the waterproofing composition comprises a functional additive.

Embodiment 46. The waterproofing composition of embodiment 45, wherein the functional additive comprises an antioxidant, an anti-caking agent, a UV stabilizer, a thermal stabilizer, a colorant, an adhesion promoter, or a combination thereof.

Embodiment 47. The waterproofing composition of embodiment 1, wherein the waterproofing composition further comprises an inert filler.

Embodiment 48. The waterproofing composition of embodiment 47, wherein the inert filler comprises limestone, talc, mica, slag, sly ash, cement, hydrate cement, aluminum trihydrate, aluminum oxide, silica (e.g. fume silica, amorphous silica), perlite, rock flower, magnesium hydroxide, magnesium silicate, calcium sulfate, diatomaceous earth, zinc oxide, glass beads, titanium dioxide, zinc borate, kaolin, colemanite, ceramics, carbon black, silica, glass fiber, a fire retardant, a renewable filler, or a combination thereof.

Embodiment 49. The waterproofing composition of embodiment 48, wherein the inert filler comprises silica, diatomaceous earth, aluminum trihydrate or a combination thereof.

Embodiment 50. The waterproofing composition of embodiment 47, wherein the inert filler does not contain multivalent cations.

Embodiment 51. The waterproofing composition of embodiment 47, wherein the inert filler has a dissociation constant, K, of less than 10-11.

Embodiment 52. The waterproofing composition of embodiment 47, wherein the inert filler comprises a combination of at least one multivalent cationic salt and at least one monovalent cationic salt.

Embodiment 53. The waterproofing composition of embodiment 47, wherein the waterproofing composition comprises at least 0.1 wt. % inert filler or at least 1 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % inert filler for a total weight of the waterproofing composition.

Embodiment 54. The waterproofing composition of embodiment 47, wherein the waterproofing composition comprises no greater than 65 wt. % inert filler or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % filler or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % inert filler for a total weight of the waterproofing composition.

Embodiment 55. The waterproofing composition of embodiment 47, wherein the waterproofing composition comprises at least 0.1 wt. % total filler or at least 1 wt. % or at least 2 wt. % or at least 3 wt. % or at least 4 wt. % or at least 5 wt. % or at least 6 wt. % or at least 7 wt. % or at least 8 wt. % or at least 9 wt. % or at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. % total filler for a total weight of the waterproofing composition.

Embodiment 56. The waterproofing composition of embodiment 47, wherein the waterproofing composition comprises no greater than 85 wt. % total filler or no greater than 84 wt. % or no greater than 83 wt. % or no greater than 82 wt. % or no greater than 81 wt. % or no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % filler or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % total filler for a total weight of the waterproofing composition.

Embodiment 57. The waterproofing composition of embodiment 1, wherein the composition comprises a critical filler concentration, C_{f} of at least 10 wt. % or at least 11 wt. % or at least 12 wt. % or at least 13 wt. % or at least 14 wt. % or at least 15 wt. % or at least 16 wt. % or at least 17 wt. % or at least 18 wt. % or at least 19 wt. % or at least 20 wt. % or at least 21 wt. % or at least 22 wt. % or at least 23 wt. % or at least 24 wt. % or at least 25 wt. % or at least 26 wt. % or at least 27 wt. % or at least 28 wt. % or at least 29 wt. % or at least 30 wt. % or at least 31 wt. % or at least 32 wt. % or at least 33 wt. % or at least 34 wt. % or at least 35 wt. % or at least 36 wt. % or at least 37 wt. % or at least 38 wt. % or at least 39 wt. % or at least 40 wt. % or at least 41 wt. % or at least 42 wt. % or at least 43 wt. % or at least 44 wt. % or at least 45 wt. % or at least 46 wt. % or at least 47 wt. % or at least 48 wt. % or at least 49 wt. % or at least 50 wt. %.

Embodiment 58. The waterproofing composition of embodiment 1, wherein the composition comprises a critical filler concentration C_{f} of no greater than 80 wt. % or no greater than 79 wt. % or no greater than 78 wt. % or no greater than 77 wt. % or no greater than 76 wt. % or no greater than 75 wt. % or no greater than 74 wt. % or no greater than 73 wt. % or no greater than 72 wt. % or no greater than 71 wt. % or no greater than 70 wt. % or no greater than 69 wt. % or no greater than 68 wt. % or no greater than 67 wt. % or no greater than 66 wt. % or no greater than 65 wt. % or no greater than 64 wt. % or no greater than 63 wt. % or no greater than 62 wt. % or no greater than 61 wt. % or no greater than 59 wt. % or no greater than 58 wt. % or no greater than 57 wt. % or no greater than 56 wt. % or no greater than 55 wt. % or no greater than 54 wt. % or no greater than 53 wt. % or no greater than 52 wt. % or no greater than 51 wt. % or no greater than 50 wt. % or no greater than 49 wt. % or no greater than 48 wt. % or no greater than 47 wt. % or no greater than 46 wt. % or no greater than 45 wt. % or no greater than 44 wt. % or no greater than 43 wt. % or no greater than 42 wt. % or no greater than 41 wt. % or no greater than 40 wt. % or no greater than 39 wt. % or no greater than 38 wt. % or no greater than 37 wt. % or no greater than 36 wt. % or no greater than 35 wt. % or no greater than 34 wt. % or no greater than 33 wt. % or no greater than 32 wt. % or no greater than 31 wt. % or no greater than 30 wt. % or no greater than 29 wt. % or no greater than 28 wt. % or no greater than 27 wt. % or no greater than 26 wt. % or no greater than 25 wt. % or no greater than 24 wt. % or no greater than 23 wt. % or no greater than 22 wt. % or no greater than 21 wt. % or no greater than 20 wt. % or no greater than 19 wt. % or no greater than 18 wt. % or no greater than 17 wt. % or no greater than 16 wt. % or no greater than 15 wt. % or no greater than 14 wt. % or no greater than 13 wt. % or no greater than 12 wt. % or no greater than 11 wt. % or no greater than 10 wt. % or no greater than 9 wt. % or no greater than 8 wt. % or no greater than 7 wt. % or no greater than 6 wt. % or no greater than 5 wt. %.

Embodiment 59. The waterproofing composition of embodiment 1, wherein the composition includes an amount of total filler within 20 wt. % of a critical filler concentration of the composition, or within 18 wt. % or within 16 wt. % or within 14 wt. % or within 12 wt. % or within 10 wt. % or within 8 wt. % or within 6 wt. % or within 5 wt. %.

Embodiment 60. The waterproofing composition of embodiment 1, wherein the composition includes an amount of swellable filler within 20 wt. % of a critical filler concentration of the composition, or within 18 wt. % or within 16 wt. % or within 14 wt. % or within 12 wt. % or within 10 wt. % or within 8 wt. % or within 6 wt. % or within 5 wt. %.

Embodiment 61. The waterproofing composition of embodiment 1, wherein the hydrophobic binder comprises an swelling per viscosity factor (bentonite), SV_{B}, of at least 0.001 mass gain %/cps or at least 0.005 mass gain %/cps or at least 0.01 mass gain %/cps or at least 0.015 mass gain %/cps or at least 0.02 mass gain %/cps.

Embodiment 62. The waterproofing composition of embodiment 1, wherein the hydrophobic binder comprises a swelling per viscosity factor (bentonite), SV_{B}, of no greater than 0.05 mass gain %/cps or no greater than 0.04 mass gain %/cps or no greater than 0.03 mass gain %/cps or no greater than 0.02 mass gain %/cps.

Embodiment 63. The waterproofing composition of embodiment 1, wherein the hydrophobic binder comprises the waterproofing composition comprises a swelling consistency factor of no greater than 400% or no greater than 350% or no greater than 300% or no greater than 250% or no greater than 200% or no greater than 150%.

Embodiment 64. The waterproofing composition of embodiment 1, wherein the waterproofing composition comprises an STi of at least 0.1 days or 0.25 days or 0.5 days or 1 day or 1.5 days or 2 days.

Embodiment 65. The waterproofing composition of embodiment 1, wherein the waterproofing composition comprises an STi of no greater than 50 days or no greater than 40 days or no greater than 30 days or no greater than 20 days or no greater than 10 days or no greater than 9 days or no greater than 8 days or no greater than 7 days or no greater than 6 days or no greater than 5 days or no greater than 4 days or no greater than 3 days or no greater than 2 days or no greater than 1 day.

Embodiment 66. The waterproofing composition of embodiment 1, wherein the waterproofing composition comprises an ST100 of at least 0.1 days or 0.25 days or 0.5 days or 1 day or 1.5 days or 2 days.

Embodiment 67. The waterproofing composition of embodiment 1, wherein the waterproofing composition comprises an ST100 of no greater than 10 days or no greater than 9 days or no greater than 8 days or no greater than 7 days or no greater than 6 days or no greater than 5 days or no greater than 4 days or no greater than 3 days or no greater than 2 days or no greater than 1 day.

Embodiment 68. The waterproofing composition of embodiment 1, wherein the waterproofing composition comprises an ST1/2 of at least 0.1 days or 0.25 days or 0.5 days or 1 day or 1.5 days or 2 days.

Embodiment 69. The waterproofing composition of embodiment 1, wherein the waterproofing composition comprises an ST1/2 of no greater than 10 days or no greater than 9 days or no greater than 8 days or no greater than 7 days or no greater than 6 days or no greater than 5 days or no greater than 4 days or no greater than 3 days or no greater than 2 days or no greater than 1 day.

Embodiment 70. The waterproofing composition of embodiment 1, wherein the hydrophobic binder comprises a swelling per viscosity factor (super absorbent polymer), SVP, of at least 0.01 mass gain %/cps or at least 0.05 mass gain %/cps or at least 0.1 mass gain %/cps or at least 0.2 mass gain %/cps or at least 0.3 mass gain %/cps or at least 0.4 mass gain %/cps or at least 0.5 mass gain %/cps or at least 0.6 mass gain %/cps or at least 0.7 mass gain %/cps or at least 08 mass gain %/cps or at least 0.9 mass gain %/cps or at least 1 mass gain %/cps.

Embodiment 71. The waterproofing composition of embodiment 1, wherein the hydrophobic binder comprises a swelling per viscosity factor (super absorbent polymer), SVP, of no greater than 20 mass gain %/cps or no greater than 18 mass gain %/cps or no greater than 16 mass gain %/cps or no greater than 14 mass gain %/cps or no greater than 12 mass gain %/cps or no greater than 10 mass gain %/cps or no greater than 8 mass gain %/cps or no greater than 6 mass gain %/cps.

Embodiment 72. The waterproofing composition of embodiment 1, wherein the composition comprises a swelling ratio, maximum swelling percentage:swellable filler concentration, of at least 0.1:1 or at least 0.5: or at least 1:1 or at least 2:1 or at least 3:1 or at least 4:1 or at least 5:1:1 or at least 6:1 or at least 7:1 or at least 8:1 or at least 9:1 or at least 10:1.

Embodiment 73. The waterproofing composition of embodiment 1, wherein the composition comprises a swelling ratio, maximum swelling percentage:swellable filler concentration, of no greater than 150:1 or no greater than 140:1 or no greater than 130:1 or no greater than 120:1 or no greater than 110:1 or no greater than 100:1 or no greater than 90:1 or no greater than 80:1 or no greater than 70:1 or no greater than 60:1 or no greater than 50:1 or no greater than 45:1 or no greater than 40:1 or no greater than 35:1 or no greater than 30:1 or no greater than 25:1 or no greater than 20:1 or no greater than 15:1 or no greater than 10:1 or no greater than 5:1.

Embodiment 74. The waterproofing composition of embodiment 1, wherein the composition comprises a ratio of swellable clay content:binder content of at least 0.1:1 or at least 0.2:1 or at least 0.3:1 or at least 0.4:1 or at least 0.5:1 or at least 0.6:1 or at least 0.7:1 or at least 0.8:1 or at least 0.9:1 or at least 1:1 or at least 1.1:1 or at least 1.2:1.

Embodiment 75. The waterproofing composition of embodiment 1, wherein the composition comprises a ratio of swellable clay content:binder content of no greater than 100:1 or no greater than 90:1 or no greater than 80:1 or no greater than 70:1 or no greater than 60:1 or no greater than 50:1 or no greater than 40:1 or no greater than 30:1 or no greater than 20:1 or no greater than 15:1 or no greater than 12:1 or no greater than 10:1 or no greater than 5:1 or not greater than 3:1 or not greater than 1:1.

Embodiment 76. The waterproofing composition of embodiment 1, wherein the composition comprises a ratio of super absorbent polymer content:binder content of at least 0.01:1 or at least 0.05:1 or at least 0.1:1 or at least 0.2:1 or at least 0.3:1 or at least 0.4:1 or at least 0.5:1 or at least 0.6:1 or at least 0.7:1 or at least 0.8:1 or at least 0.9:1 or at least 1:1 or at least 1.1:1 or at least 1.2:1.

Embodiment 77. The waterproofing composition of embodiment 1, wherein the composition comprises a ratio of super absorbent polymer content:binder content of no greater than 100:1 or no greater than 90:1 or no greater than 80:1 or no greater than 70:1 or no greater than 60:1 or no greater than 50:1 or no greater than 40:1 or no greater than 30:1 or no greater than 20:1 or no greater than 15:1 or no greater than 12:1 or no greater than 10:1 or no greater than 5:1 or not greater than 3:1 or not greater than 1:1.

Embodiment 78. The waterproofing composition of embodiment 1, wherein the composition comprises a sublayer of swellable filler sandwiched between two hydrophobic binder sublayers.

Embodiment 79. A method of making a waterproofing composition comprising:
mixing a hydrophobic binder with a swellable filler, the hydrophobic binder comprising at least one of the following:
   a) a polymer modified asphalt comprising asphalt and a polymer additive;
   b) a hot melt adhesive; and
   c) a thermoplastic polymer;
and
a swellable filler comprising at least one of the following:

(i) at least 15 wt. % and no greater than 85 wt. % of a swellable clay, and
(ii) at least 0.1 wt. % and no greater than 70 wt. % of a super absorbent polymer;
   wherein the amounts in wt. % are based on a total weight of the waterproofing composition.

Embodiment 80. The method of embodiment 79, further comprising mixing an asphalt with a polymer additive to form the hydrophobic binder.

Embodiment 81. The method of embodiment 80, wherein a process oil is mixed with the asphalt and polymer additive to form the hydrophobic binder.

Embodiment 82. The method of any one of embodiments 79-81, wherein the waterproofing composition is the waterproofing composition of any one of embodiments 1 to 78.

Embodiment 83. A waterproofing article comprising: a first swellable layer comprising the waterproofing composition of any one of embodiments 1 to 78, and a reinforcing layer.

Embodiment 84. The waterproofing article of embodiment 83, wherein the waterproofing article comprises a front side configured to adhere to pre- or post-cast concrete or shotcrete and a rear side configured to face soil or a water table.

Embodiment 85. The waterproofing article of embodiment 83, wherein the waterproofing article comprises a rear side configured to adhere to pre- or post-cast concrete or shotcrete and a front side configured to face soil or a water table.

Embodiment 86. The waterproofing article of embodiment 83, wherein the first swellable layer overlies the reinforcing layer.

Embodiment 87. The waterproofing article of embodiment 84, wherein the first swellable layer is on the rear side of the article relative to the reinforcing layer.

Embodiment 88. The waterproofing article of embodiment 83, wherein the reinforcing layer comprises PET mesh; a glass mat; a woven or non-woven fabric comprising acrylic acid or acrylate homo or copolymer, polyvinyl chloride (PVC), polyethylene terephthalate (PET), neoprene, nylon, polyurethane, or a combination thereof; or a combination thereof.

Embodiment 89. The waterproofing article of embodiment 83, wherein the reinforcing layer comprises asphalted coated PET mesh.

Embodiment 90. The waterproofing article of embodiment 83, wherein the reinforcing layer has an areal density of at least 0.09 lbs/sq ft. and/or not greater than 0.14 lbs/sq ft.

Embodiment 91. The waterproofing article of embodiment 83, further comprising a backing such that the backing forms the rear side of the article.

Embodiment 92. The waterproofing article of embodiment 91, wherein the backing comprises a film, a woven or nonwoven mat, inorganic or organic fibers, fiberglass, ceramic fibers, polymer fibers, polyester fibers, polyolefin fibers, sand, a swellable clay, or a combination thereof.

Embodiment 93. The waterproofing article of embodiment 92, wherein the film comprises a release film, a burn off film, a sacrificial film, or a combination thereof.

Embodiment 94. The waterproofing article of embodiment 91, further comprising a second functional layer adjacent the reinforcing layer opposite the first swellable layer.

Embodiment 95. The waterproofing article of embodiment 94, wherein the second functional layer comprises a second swellable layer.

Embodiment 96. The waterproofing article of embodiment 94, wherein the second functional layer is configured to adhere to pre or post cast concrete or shotcrete.

Embodiment 97. The waterproofing article of embodiment 94, wherein the second functional layer forms the front side of the waterproofing article.

Embodiment 98. The waterproofing article of embodiment 94, further comprising particulate material embedded in a top surface of the second functional layer.

Embodiment 99. The waterproofing article of embodiment 98, wherein the particulate material comprises granules, sand, a swellable clay, cement, hydrated cement, limestone, slag fly ash or a combination thereof.

Embodiment 100. The waterproofing article of embodiment 98, wherein the particulate material comprises a particle size of at least 10 microns and no greater than 5000 microns or at least 100 microns and no greater than 1000 microns.

Embodiment 101. The waterproofing article of embodiment 99, wherein the top surface of the second functional layer, including the particulate material, comprises a reflectivity of at least 5% or at least 10% or at least 15% or at least 20% or at least 25% or at least 30% or at least 35% or at least 40% or at least 5% or at least 50% or at least 55% or at least 60% or at least 65% or at least 70% or at least 75% or at least 80% or at least 85% or at least 90% or at least 95%.

Embodiment 102. The waterproofing article of embodiment 99, wherein the top surface of the second functional layer, including the particulate material, comprises a reflectivity of not greater than 95% or not greater than 90% or not greater than 85% or not greater than 80% or not greater than 5% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10% or not greater than 5%.

Embodiment 103. The waterproofing article of embodiment 98, wherein the particulate material comprises a functional coating.

Embodiment 104. The waterproofing article of embodiment 94, further comprising a polymeric course overlying the second functional layer.

Embodiment 105. The waterproofing article of embodiment 103, wherein the polymer course comprises a textile, a nonwoven, a polymer film such as HDPE, PP, or acrylic, a release film, a burn-off film, a sacrificial film, or a combination thereof.

Embodiment 106. The waterproofing article of any one of embodiments 94 or 98-103, wherein the second functional layer comprises an adhesion to pre or post cast concrete or shotcrete of at least 2 pli or at least 3 pli or at least 4 pli or at least 5 pli.

Embodiment 107. The waterproofing article of any one of embodiments 94 or 98-103, wherein the second functional layer comprises an adhesion to pre or post cast concrete or shotcrete of no greater than 50 or no greater than 45 or no greater than 40 or no greater than 35 or no greater than 30 or no greater than 25 or no greater than 20 pli or no greater than 19 pli or no greater than 18 pli or no greater than 17 pli or no greater than 16 pli or no greater than 15 pli.

Embodiment 108. A waterproofing article comprising:
a backing layer,
a first functional layer overlying the backing layer,
a reinforcing layer overlying the first functional layer,
a second functional layer overlying the second functional layer;
wherein at least one of the first functional layer or the second functional layer comprises
   the waterproofing composition of anyone of embodiments 1 to 78.

Embodiment 109. A method of making a waterproofing article comprising:
forming a first functional layer by depositing a waterproofing composition onto a reinforcing layer or by depositing a swellable filler sandwiched between two layers of hydrophobic binders onto a reinforcing layer,
the waterproofing composition comprising a hydrophobic binder, the hydrophobic binder comprising at least one of the following:
   a) a polymer modified asphalt comprising asphalt and a polymer additive;
   b) a hot melt adhesive; and
   c) a thermoplastic polymer;
and
a swellable filler comprising at least one of the following:
   (i) at least 15 wt. % and no greater than 85 wt. % of a swellable clay, and
   (ii) at least 0.1 wt. % and no greater than 70 wt. % of a super absorbent polymer;
   wherein the amounts in wt. % are based on a total weight of the waterproofing composition.

Embodiment 110. The method of embodiment 109 wherein the waterproofing composition comprises the waterproofing composition of any one of embodiments 1 to 78.

Embodiment 111. The method of embodiment 109 wherein the waterproofing article comprises the waterproofing article of any one of embodiments 83 to 108.

Embodiment 112. A method of waterproofing a concrete structure comprising applying a waterproofing article according to embodiments 83 to 108 to a building substrate or concrete or shotcrete form with front side of said membrane facing the area into which the concrete or shotcrete will be cast, and casting concrete such that the concrete contacts the releasable material of the membrane.

Embodiment 113. A method of waterproofing a concrete structure comprising applying a waterproofing article according to embodiments 83 to 108 to already cast concrete.

### EXAMPLES

### Example 1—Preparation of Waterproofing Compositions

Waterproofing compositions including a hydrophobic binder such as polymer modified asphalt and a swellable filler such as bentonite were prepared according to table 1 using the processing steps as described herein. Asphalt flux was added to a 1-quart vessel heated to 365° F. under light agitation (60-120 RPM) with a Silverson LM5-A high-shear mixer. Polymers such as styrene-butadiene-styrene (SBS), styrene-isoprene-styrene (SIS) and/or other polymer rubbers were added to the asphalt flux and mixed for 5 minutes to fully disperse the polymer pellets in the liquid asphalt. The mixture is then agitated at higher shear rates (1200-1600 RPM) for 30 minutes to dissolve the dispersed polymer pellets into the asphalt to form the polymer modified asphalt (PMA) hydrophobic binder. Care is taken to make sure the temperature stays within the 365-390° F. range to avoid crosslinking of the polymer. The polymer modified asphalt mixture is moved to a new mixer equipped with a Cowles blade agitator. Under 300-600 rpm mixing, process oil is added to the PMA mixture and allowed to mix for about 10 minutes. Meanwhile, 40 mesh bentonite (i.e. bentonite sized to through a screen having 40 openings per inch) was dried at 250° F. The mixer temperature was increased to 375° F. and the bentonite and/or super absorbent polymer was added and mixed for 15 minutes to form the waterproofing composition described in table 1.

TABLE 1
Waterproofing compositions having Swellability

| | | Asphalt | SBS | Process Oil | Bentonite | |
|---|---|---|---|---|---|---|
| | Sample | Content | content | Content | Content | SAP |
| Sample | 1A | 34-36 wt. % | 4-6 wt. % | 0 wt. % | 60 wt. % | 0 wt. % |
| Nos. 1 | | | (Radial | | | |
| (Bentonite | | | SBS) | | | |
| as | 1B | 39-41 wt. % | 4-6 wt. % | 0 wt. % | 55 wt. % | 0 wt. % |
| swellable | | | (Radial | | | |
| filler; | | | SBS) | | | |
| without | 1C | 62-63 wt. % | 7-8 wt. % | 0 wt. % | 30 wt. % | 0 wt. % |
| process | | | (Radial | | | |
| oil) | | | SBS) | | | |
| | 1D | 75-76 wt. % | 9-10 wt. % | 0 wt. % | 15 wt. % | 0 wt. % |
| | | | (Radial | | | |
| | | | SBS) | | | |
| | 1E | 88-90 wt. % | 10-12 wt. % | 0 wt. % | 0 wt. % | 0 wt. % |
| | | | (Radial | | | |
| | | | SBS) | | | |
| Sample | 2A | 65-66 wt. % | 7-8 wt. % | 7-8 wt. % | 20 wt. % | 0 wt. % |
| Nos. 2 | | | (Linear | | | |
| (Bentonite | | | SBS) | | | |
| as | 2B | 49-50 wt. % | 5-6 wt. % | 5-6 wt. % | 40 wt. % | 0 wt. % |
| swellable | | | (Linear | | | |
| filler and | | | SBS) | | | |
| process | 2C | 40-42 wt. % | 4-5 wt. % | 4-5 wt. % | 50 wt. % | 0 wt. % |
| oil; linear | | | (Linear | | | |
| SBS) | | | SBS) | | | |
| | 2D | 32-34 wt. % | 3-4 wt. % | 3-4 wt. % | 60 wt. % | 0 wt. % |
| | | | (Linear | | | |
| | | | SBS) | | | |
| Sample | 3B | 48-50 wt. % | 5-6 wt. % | 5-6 wt. % | 40 wt. % | 0 wt. % |
| Nos. 3 | | | (Radial | | | |
| (Bentonite | | | SBS) | | | |
| as | 3C | 45-46 wt. % | 4-5 wt. % | 4-5 wt. % | 45 wt. % | 0 wt. % |
| swellable | | | (Radial | | | |
| filler; | | | SBS) | | | |
| process | 3D | 40-41 wt. % | 4-5 wt. % | 4-5 wt. % | 50 wt. % | 0 wt. % |
| oil; and | | | (Radial | | | |
| Radial | | | SBS) | | | |
| SBS) | 3E | 36-37 wt. % | 3-5 wt. % | 3-5 wt. % | 55 wt. % | 0 wt. % |
| | | | (Radial | | | |
| | | | SBS) | | | |
| | 3F | 32-33 wt. % | 3-4 wt. % | 3-4 wt. % | 60 wt. % | 0 wt. % |
| | | | (Radial | | | |
| | | | SBS) | | | |

Viscosity

| | | | | | | |
|---|---|---|---|---|---|---|
| Samples | 4A | 61-64 wt. % | 6-9 wt. % | 0 wt. % | 30 wt. % | 0 wt. % |
| Nos. 4 | | | (Radial | | | |
| (Bentonite | | | SBS) | | | |
| as | 4B | 43-47 wt. % | 3-7 wt. % | 0 wt. % | 50 wt. % | 0 wt. % |
| swellable | | | (Radial | | | |
| filler; | | | SBS) | | | |
| without | 4C | 38-42 wt. % | 3-7 wt. % | 0 wt. % | 55 wt. % | 0 wt. % |
| process | | | (Radial | | | |
| oil; and | | | SBS) | | | |
| with | 4D | 33-37 wt. % | 3-7 wt. % | 0 wt. % | 60 wt. % | 0 wt. % |
| Radial | | | (Radial | | | |
| SBS) | | | SBS) | | | |
| | 4E | 24-28 wt. % | 2-6 wt. % | 0 wt. % | 70 wt. % | 0 wt. % |
| | | | (Radial | | | |
| | | | SBS) | | | |

Viscosity and Swelling

| | | | | | | |
|---|---|---|---|---|---|---|
| Samples | 3B/7A* | 45-46 wt. % | 4-5 wt. % | 4-5 wt. % | 45 wt. % | 0 wt. % |
| No. 7 | | | (Radial | | | |
| (Bentonite | | | SBS) | | | |
| & SAP as | 7B | 40-41 wt. % | 4-5 wt. % | 4-5 wt. % | 45 wt. % | 5 wt. % |
| swellable | | | (Radial | | | |
| filler; | | | SBS) | | | |
| with | 7C | 36-37 wt. % | 3-5 wt. % | 3-5 wt. % | 45 wt. % | 10 wt. % |
| process | | | (Radial | | | |
| oil; and | | | SBS) | | | |
| with | | | | | | |
| Radial | | | | | | |
| SBS) | | | | | | |

Induction Time

| | | | | | | |
|---|---|---|---|---|---|---|
| Sample | 8 | 48-50 wt. % | 5-6 wt. % | 5-6 wt. % | 20 wt. % | 20 wt. % |
| No. 8 | | | (Radial | | | |
| (Bentonite | | | SBS) | | | |
| & SAP as | | | | | | |
| swellable | | | | | | |
| filler; | | | | | | |
| with | | | | | | |
| process | | | | | | |
| oil; and | | | | | | |
| with | | | | | | |
| Radial | | | | | | |
| SBS) | | | | | | |

*Samples 7A and 3B are the same sample. Sample 3 is a series of samples with a particular binder and viable bentonite concentration including sample 3B within 45 wt. % bentonite while sample 7 is a series of samples with 45 wt. % bentonite and variable SAP testing. Only 1 sample was evaluated but it is referred to as 7A or 3B depending on the context.

### Example 2—Swell Testing (Swelling as Measured by Δ Mass (%)) of the Waterproofing Compositions of Sample Nos. 1-3 of Example 1

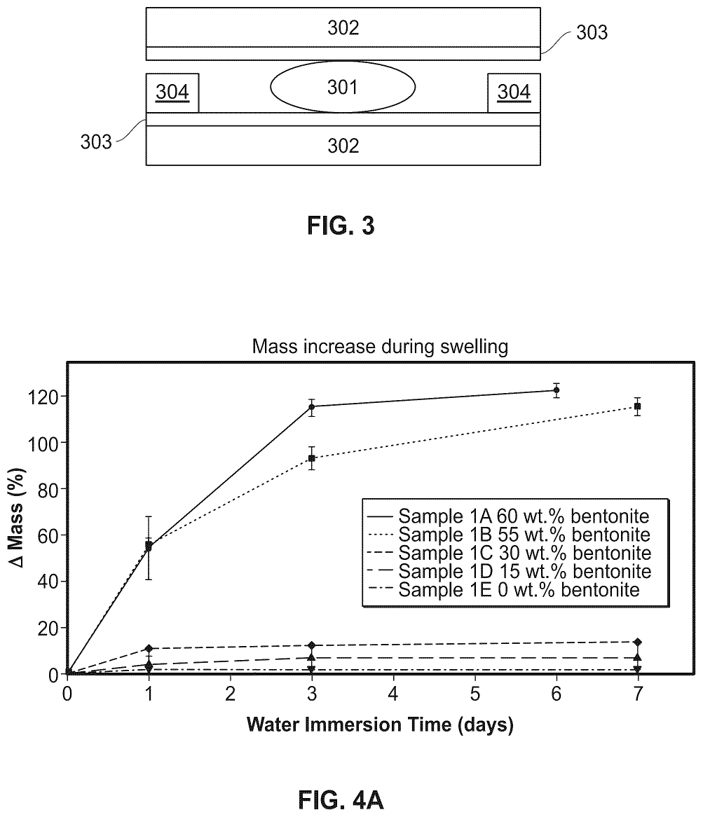

Waterproofing compositions of Sample Nos. 1-3 from the Example 1 were cut into 150 g samples and pre-shaped into a spherical/ball shape 301, as shown in FIG. 3. The ball 301 is sandwiched between two steel plates 302 lined with a sheet of PET release liner 303 according to FIG. 3. The steel plate is supported by 20 mil thick shims 304. The arranged sample with the shim and plates is placed in a Carver press (Model #: 3892.4PL000) having platens set to 240° F. The press is set to 1000 lb. force, and the sample is pressed into a 20-mil thick puck having diameter of 6″. The puck is frozen to −11° F. and then cut into twelve 1″×1″ squares. Precise length and width are measured via ruler. Thickness is measured via caliper. Mass measurements are taken with Metler-Toledo AX2202/E. The squares are then left in a room temperature water bath with excess water, for 24 hours and the measurements are repeated. The soaking and measuring are repeated for about 5 days, until the sample no longer noticeably swells. As used herein, change in mass of each of the square from prior to soaking in excess water and after soaking the same sample in excess water for a certain period of time, calculated as Δ Mass (%), is referred to as swelling.

FIGS. 4A and 4B shows a plot of swelling (Δ Mass (%)) over water immersion time (in days) for Sample Nos. 1A-1E and 3A-3F respectively. FIG. 5 shows a plot of maximum swelling (Maximum Δ Mass (%)) vs bentonite content for Sample Nos. 2 (PMA with linear SBS) and 3 (PMA with Radial SBS). For a particular hydrophobic binder compositions, there exists a critical filler content, (herein referred to as the C_{f}), above which the changes in filler concentrations dramatically change material properties. For example, as can been seen in FIGS. 4A and 4B, the swellability of the waterproofing composition with bentonite as the swellable filler increases much more dramatically with increasing bentonite content. This dramatic increase in swellability can be seen in FIGS. 4A, where there are smaller increases in swelling (Δ Mass (%)) as a function of time up to 30% but a major jump (larger (Δ Mass (%)) when bentonite content is increased to 55%) and 4B (where increasing bentonite from 20 wt. % to 40 wt. % provides the same swelling increase as increasing bentonite from 40 wt. % to 45 wt. %. Increased swelling is desirable but must be balanced against other material properties.

Also notable in FIG. 5 is the slightly higher swelling ((Maximum Δ Mass (%)) for the Sample Nos 3 with radial SBS as compared to Sample Nos. 2 with linear SBS. Without being bound to any particular theory, it is believed that this is the result of the radial SBS additive resulting in a softer polymer modified asphalt binder. The maximum swelling expressed as the maximum % increase in mass may be referred to as a maximum swelling percentage in this application.

### Example 3—Viscosity of the Waterproofing Compositions Comprising Bentonite as the Swellable Filler

The waterproofing compositions of the Sample Nos. 4A-E shown in Table 1 were shaped into discs of 1 inch diameter, 2-3 mm thickness. Viscosity was measured at 375° F. for the shear rates of 39.8 and 6.3/s, using TA AR200ex rheometer equipped with the 25 mm steel parallel plates. Results can be seen in FIG. 6. As can been seen in FIG. 6, there exists a critical bentonite content, (C_{f}), above which the material properties, in this instance viscosity, of the waterproofing composition with bentonite as the swellable filler change much more dramatically with increasing bentonite content.

### Example 4—Viscosity and Swelling Behavior of the Waterproofing Compositions Comprising Bentonite as the Swellable Filler

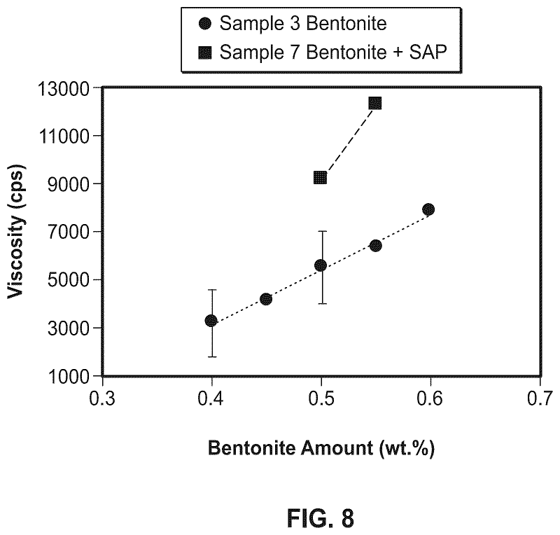

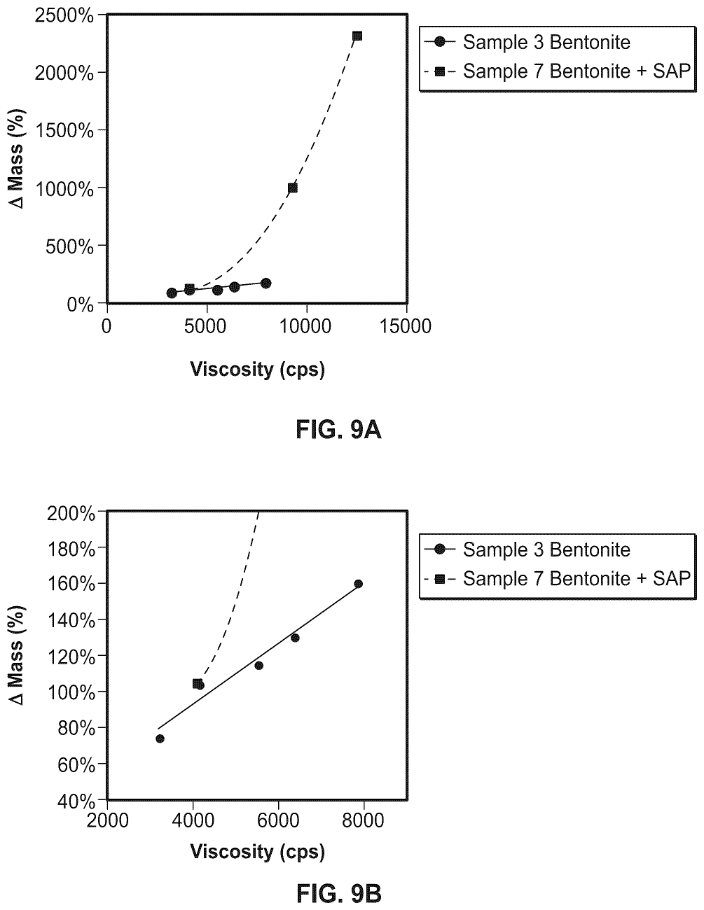

Viscosity (39.8/s shear rate) and swelling of the waterproofing compositions of Sample Nos. 3 and 7 were measured according to Example Nos. 3 and 2 respectively. The waterproofing compositions of Sample No. 3 includes a polymer modified asphalt as the hydrophobic binder and variable bentonite content as the swellable filler. FIG. 8 shows viscosity as a function of the bentonite content (wt. %) for Sample Nos. 3 and 7. FIGS. 9A and 9B shows maximum swelling ((Maximum Δ Mass (%)) as a function of viscosity for waterproofing compositions of Sample No. 3. A trend line was plotted through all sample 3 variations, the slope of which defines the swelling per viscosity factor (bentonite), SV_{B}, the subscript “B” denoting this factor applies to waterproofing compositions comprising PMA with variable bentonite and no SAP. The slope for SV_{B} should be measured from samples having variable bentonite in the 40-60 wt. % range. Similarly, a trend line was plotted through all sample 7 variations, the slope of which defines the swelling per viscosity factor (super absorbent polymer), SV_{P}, the subscript “P” denoting this factor applies to waterproofing compositions comprising of PMA, and both bentonite and SAP as swellable filler. The slope for SV_{P} should be measured from samples having variable bentonite in the 0-20 wt. % range. A high swelling per viscosity content is desired as too high a viscosity can introduce processability issues.

### Example 5—Induction Time

The waterproofing compositions of the Sample Nos. 3B, 3D, 7B, 7C, and 8 were allowed to swell according to example 2. Plots of swelling over time can be found in FIGS. 10A, 10B, 11A, and 11B. FIGS. 10A and 10B show the same curve, with 10B being focused on the first 3 days of swelling. FIGS. 11A and 10B show the same curve, with 11B being focused on the first 3 days of swelling. on the start. Notably, some of the curves (Samples 7B and 8) have a delayed swell time. The inventors believe that this delayed swell time when in contact with water can be beneficial so that products may be set up in inclement weather, e.g., rain, without premature swelling before installation. Alternatively, some applications may call for a composition that swells as fast as possible. The delayed swell time can be quantified according to the following parameters:
1) The inflection point referred to as STᵢ, determined from the plot of swelling (Δ Mass (%)) as a function of time;
2) The time to swell 100% referred to as ST₁₀₀, determined from the plot of swelling (Δ Mass (%)) as a function of the amount of the swellable filler in the waterproofing composition; and
3) The time to swell to half of the maximum swelling ST_{1/2}, determined from the plot of swelling (Δ Mass (%)) as a function of time.

### Example 6—Preparation of a Waterproofing Article

A waterproofing composition for Sample No. 5 was prepared according to the following process and the composition in table 2 below. Asphalt flux was added to a 1-quart vessel heated to 325° F. under light agitation (60-120 RPM) with a Silverson LM5-A high-shear mixer. Polymers and/or rubbers such as SBS (linear and/or radial) and SIS were added and mixed for 5 minutes to fully disperse the polymer pellets in the liquid asphalt. The mixture is then agitated at higher shear rates (1200-1600 RPM) for 30 minutes to dissolve the dispersed polymer pellets into the asphalt. Care is taken to make sure the temperature stays below 350° F. to avoid crosslinking of the polymer. Next, resin tackifier was added and mixed over 5 minutes under agitation by a Cowles blade mixer (300-600 RPM) at 300° F. Inert filler such as limestone, aluminum trihydrate, or zinc borate is then added and dispersed at 375° F. under agitation (Cowles blade, 300-600 rpm) to form the waterproofing composition.

TABLE 2
Sample No. 6

| Component | Wt. % |
|---|---|
| Asphalt | 45-70% |
| Process oil | 0-8% |
| SBS | 0-22% |
| SIS | 0-5% |
| Tackifier | 0-9% |
| Inert Filler | 0-40% |

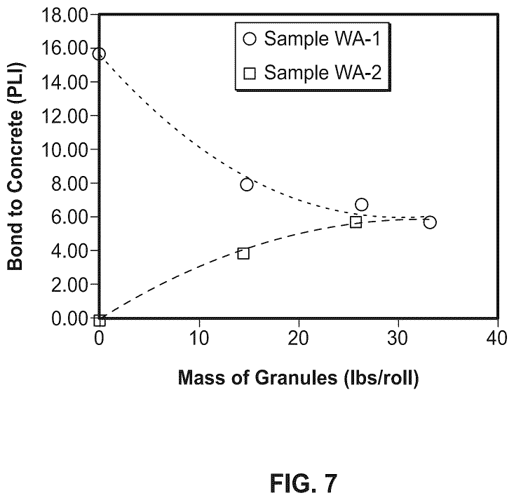

The waterproofing composition was prepped into rolls of 15 lbs., 100 sq. ft, reinforced with a PET fleece in back, and coated with granules in front in amounts of 0-35 lbs/roll to prepare the waterproofing article Sample No. WA-1. The waterproofing article, Sample WA-2 was recreated and treated with UV exposure per ASTM G154 to prepare the waterproofing article, Sample No. WA-2, also coated with granules per FIG. 7. The waterproofing articles, Sample Nos. WA-1 and WA-2 were stored at room temperature for 3 days and then evaluated according to ASTM D3330 for bond to concrete with a modification that the concrete is cast onto the membrane and allowed to cure for 7 days. Results can be found in FIG. 7.

### Example 7—Rebar Testing

The waterproofing articles comprising the waterproofing compositions as described hereinabove may be evaluated according to a modified ASTM D5385/D5385M-93 as well as a modified ASTM 1970.

### Example 8-Effect of Fillers in the Waterproofing Compositions Comprising Super Absorbent Polymer (SAP) on Swelling Consistency

Waterproofing compositions including a polymer modified asphalt as the hydrophobic binder and a super absorbent polymer or bentonite as the swellable filler were prepared according to table 3 and the steps detailed in example 2 to form the waterproofing compositions corresponding to Sample Nos. CS1, S9, and S10 of Table 3.

TABLE 3
Fillers and Swelling Consistency

| | Asphalt | | Process Oil | Limestone | | Bentonite |
|---|---|---|---|---|---|---|
| Sample | Content | SBS content | Content | filler | SAP | content |
| CS1 | 72-75 wt. % | 7-9 wt. % | 7-9 wt. % | 0 wt. % | 10 wt. % | 0 wt. % |
| | | (Radial SBS) | | | | |
| S9 | 36-37 wt. % | 3-5 wt. % | 3-5 wt. % | 45 wt. % | 10 wt. % | 0 wt. % |
| | | (Radial SBS) | | | | |
| S10 | 36-37 wt. % | 3-5 wt. % | 3-5 wt. % | 0 wt. % | 10 wt. % | 45 wt. % |
| | | (Radial SBS) | | | | |

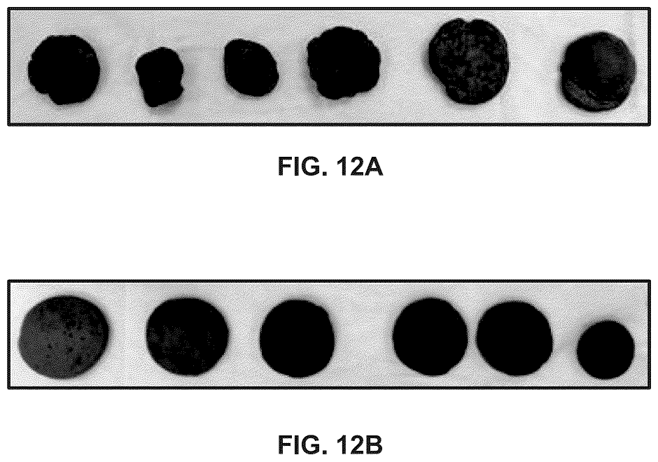

The waterproofing compositions corresponding to Sample Nos. S9, S10, and CS1 were shaped and had their swelling evaluated according to the process in example 2. FIGS. 12A and 12B includes images of pucks after 17 days of swelling for Sample Nos. CS1 and S9 respectively. FIG. 13 shows a plot of swelling ((Δ Mass (%)) over time for Sample Nos. CS1 and S9. FIG. 14 shows a plot of swelling variability among six samples having the same waterproofing compositions over time, as shown by swelling ((Δ Mass (%)). Swelling variability is measured by taking the standard deviation of the swelling ((Δ Mass (%)) of the six samples. The maximum standard deviation recorded may be referred to as a swelling consistency factor. It should be noted in FIG. 14, that the waterproofing compositions corresponding to Sample Nos. S9 and S10 having either inert filler or swellable filler along with swellable SAP displayed smaller swelling variability as compared to the Sample No. CS1 having SAP, but no inert filler or swellable filler. Without wishing to be bound to any particular theory, the inventors believes that waterproofing compositions with amounts of filler (inert and/or swellable) near the critical filler concentration will exhibit much more even swelling.

### Example 9—Effect of the Inert Filler on in the Waterproofing Compositions Comprising SAP on Swelling Poisoning

Various waterproofing compositions including a PMA as the hydrophobic binder and a bentonite or super absorbent polymer as a swellable filler. were prepared according to table 4 and the steps detailed in example 1.

TABLE 4
Swelling Poisoning

| | Asphalt | SBS | Process Oil | Inert Filler | Bentonite | |
|---|---|---|---|---|---|---|
| Sample | Content | content | Content | Content | Content | SAP |
| CS2 | 40-44 wt. % | 3-5 wt. % | 11-13 wt. % | 30 wt. % | 0 wt. % | 12 wt. % |
| | | (Radial | | Limestone | | |
| | | SBS) | | | | |
| S11 | 60-65 wt. % | 6-8 wt. % | 17-19 wt. % | 0 wt. % | 0 wt. % | 12 wt. % |
| | | (Radial | | | | |
| | | SBS) | | | | |
| CS3 | 51-55 wt. % | 5-7 wt. % | 11-13 wt. % | 10 wt. % | 10 wt. % | 9 wt. % |
| | | (Radial | | Limestone | | |
| | | SBS) | | | | |
| S12A | 51-55 wt. % | 5-7 wt. % | 11-13 wt. % | 10 wt. % | 10 wt. % | 9 wt. % |
| | | (Radial | | Silica | | |
| | | SBS) | | | | |
| S12B | 43-47 wt. % | 4-6 wt. % | 9-11 wt. % | 20 wt. % | 10 wt. % | 9 wt. % |
| | | (Radial | | Silica | | |
| | | SBS) | | | | |
| S12C | 36-41 wt. % | 3-5 wt. % | 7-10 wt. % | 30 wt. % | 10 wt. % | 9 wt. % |
| | | (Radial | | Silica | | |
| | | SBS) | | | | |
| S13A | 51-55 wt. % | 5-7 wt. % | 11-13 wt. % | 10 wt. % | 10 wt. % | 9 wt. % |
| | | (Radial | | Aluminum | | |
| | | SBS) | | Trihydrate | | |
| S13B | 43-47 wt. % | 4-6 wt. % | 9-11 wt. % | 20 wt. % | 10 wt. % | 9 wt. % |
| | | (Radial | | Aluminum | | |
| | | SBS) | | Trihydrate | | |
| S13C | 36-41 wt. % | 3-5 wt. % | 7-10 wt. % | 30 wt. % | 10 wt. % | 9 wt. % |
| | | (Radial | | Aluminum | | |
| | | SBS) | | Trihydrate | | |
| S14A | 51-55 wt. % | 5-7 wt. % | 11-13 wt. % | 10 wt. % | 10 wt. % | 9 wt. % |
| | | (Radial | | Perlite | | |
| | | SBS) | | | | |
| S14B | 43-47 wt. % | 4-6 wt. % | 9-11 wt. % | 20 wt. % | 10 wt. % | 9 wt. % |
| | | (Radial | | Perlite | | |
| | | SBS) | | | | |
| S14C | 36-41 wt. % | 3-5 wt. % | 7-10 wt. % | 30 wt. % | 10 wt. % | 9 wt. % |
| | | (Radial | | Perlite | | |
| | | SBS) | | | | |
| S15 | 58-62 wt. % | 6-8 wt. % | 13-14 wt. % | 0 wt. % | 10 wt. % | 9 wt. % |
| | | (Radial | | | | |
| | | SBS) | | | | |
| S16A | 42-46 wt. % | 4-6 wt. % | 11-13 wt. % | 30 wt. % | 0 wt. % | 9 wt. % |
| | | (Radial | | Limestone | | |
| | | SBS) | | | | |
| S16B | 38-42 wt. % | 3-5 wt. % | 10-12 wt. % | 30 wt. % | 5 wt. % | 9 wt. % |
| | | (Radial | | Limestone | | |
| | | SBS) | | | | |
| S16C | 35-39 wt. % | 3-5 wt. % | 9-11 wt. % | 30 wt. % | 10 wt. % | 9 wt. % |
| | | (Radial | | Limestone | | |
| | | SBS) | | | | |
| CSS16D | 31-35 wt. % | 3-5 wt. % | 8-10 wt. % | 30 wt. % | 15 wt. % | 9 wt. % |
| | | (Radial | | Limestone | | |
| | | SBS) | | | | |

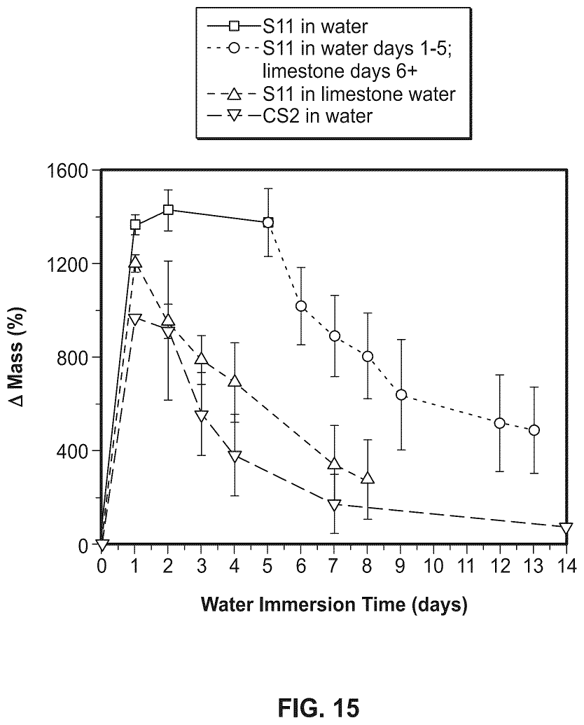

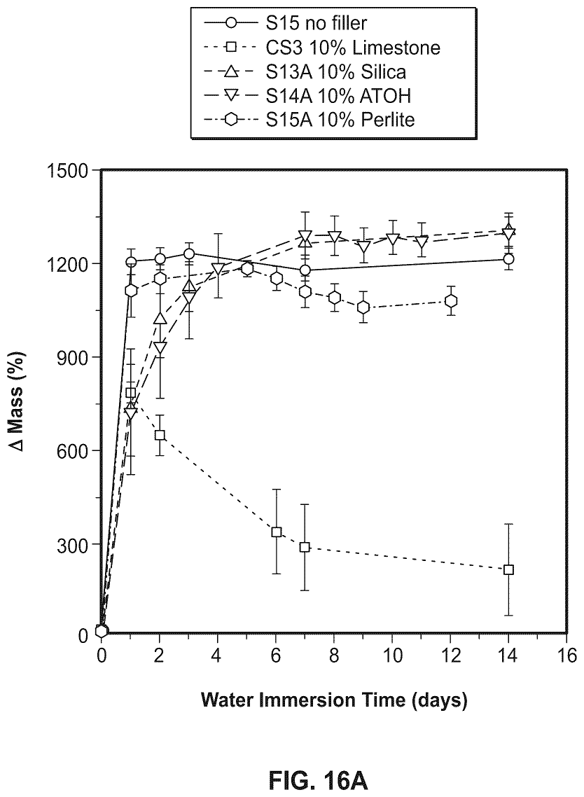

The waterproofing compositions corresponding to Sample Nos. S11 and CS2 were shaped and had their swelling evaluated according to the process detailed in example 2. The soaking and measuring are repeated for about 15 days. An additional version of Sample S11 is left in water bath having limestone in the bath but not the sample. A third version of sample S11 started in regular water but is transferred to limestone water after 5 days. FIG. 15 shows a plot of swelling ((Δ Mass (%)) as a function of time for Sample Nos. S11 and CS2 under various conditions (in water only; in limestone water only; and in water for 1-5 days and in limestone water for additional days). Notably, the samples containing limestone, or left in limestone water had noticeable deswelling. Without being bound to any particular theory, it is believed that the calcium ions in the limestone dissociate in the water and interfere with the swelling mechanism of the acrylate based super absorbent polymer.

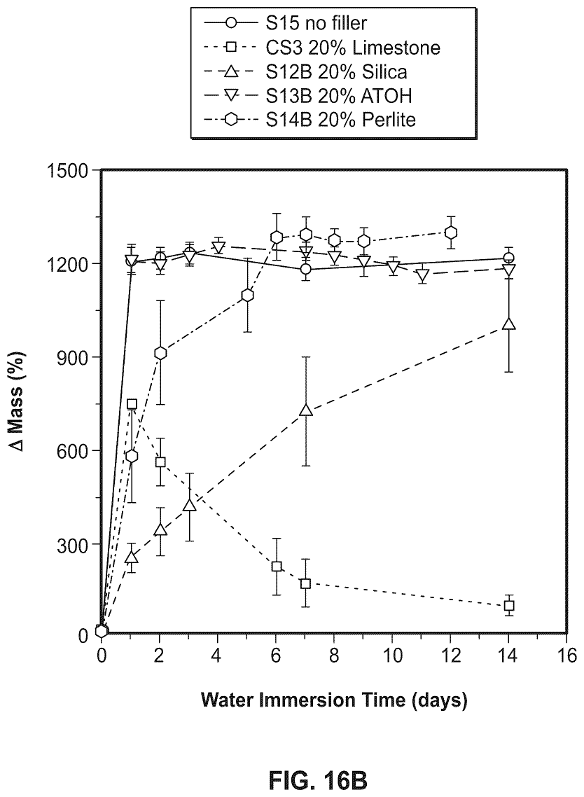

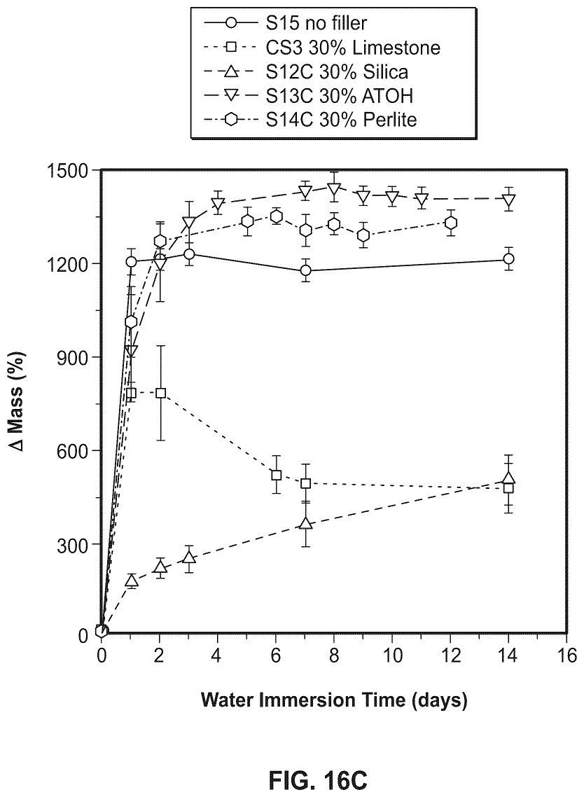

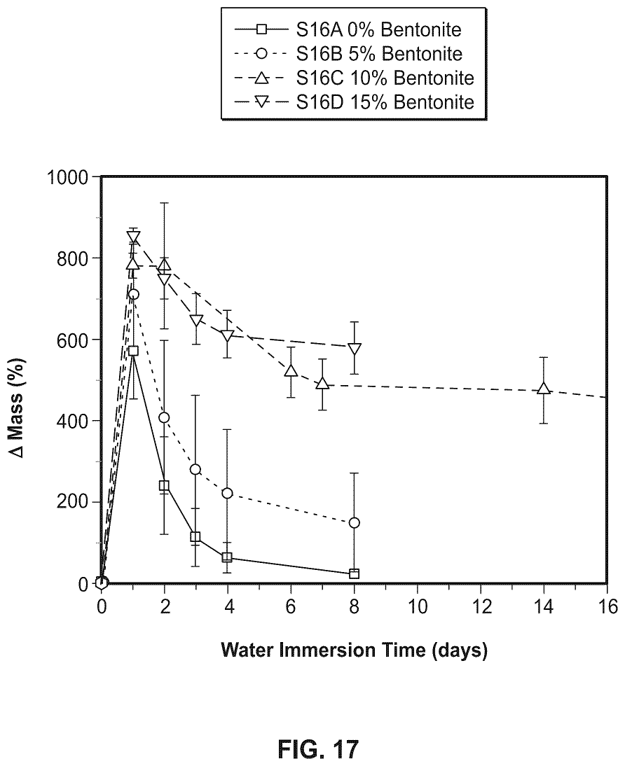

Samples S12-S16, S13, and comparative sample CS3 were shaped and had their swelling evaluated according to the process detailed in example 2. FIGS. 16A-16C shows a plot of swelling ((Δ Mass (%)) as a function of water immersion time for Sample Nos. S12-S14, S15 each having different inert filler (no filler, silica, aluminum trihydroxide (ATOH), and perlite), and comparative sample CS3. Comparative sample CS3 with limestone exhibited significant deswelling as compared to other samples with no filler or other inert fillers such as silica, ATOH, and Perlite. FIG. 17 shows a plot of swelling ((Δ Mass (%)) as a function of water immersion time for samples S16A-S16D, each having different amount of bentonite in addition to SAP and limestone. Notably, increasing the concentration of bentonite reduced deswelling. Without being bound to any particular theory, it is believed that the bentonite contains monovalent sodium cations which interfere with the deswelling caused by limestone.

### Example 10—Effect of Hydrophobic Binder (Stiff Versus Soft) in the Waterproofing Composition on Swelling

The waterproofing compositions including a PMA as the hydrophobic binder and a super absorbent polymer and/or bentonite as the swellable filler were prepared according to table 5 the process detailed in example 1.

TABLE 5
Soft Vs. Stiff Binders

| | Asphalt | SBS | Process Oil | Limestone | Bentonite | |
|---|---|---|---|---|---|---|
| Sample | Content | content | Content | Content | Content | SAP |
| S17 (“Soft” | 56-60 wt. % | 5-7 wt. % | 15-17 wt. % | 0 wt. % | 10 wt. % | 9 wt. % |
| binder) | | (Radial | | | | |
| | | SBS) | | | | |
| S18 (“Soft” | 35-39 wt. % | 3-5 wt. % | 9-11 wt. % | 30 wt. % | 10 wt. % | 9 wt. % |
| binder with | | (Radial | | Limestone | | |
| limestone) | | SBS) | | | | |
| S19 (“Stiff” | 70-72 wt. % | 9-11 wt. % | 0 wt. % | 0 wt. % | 10 wt. % | 9 wt. % |
| binder) | | (Radial | | | | |
| | | SBS) | | | | |
| S20 (“Stiff” | 44-46 wt. % | 5-7 wt. % | 0 wt. % | 30 wt. % | 10 wt. % | 9 wt. % |
| binder with | | (Radial | | Limestone | | |
| limestone | | SBS) | | | | |

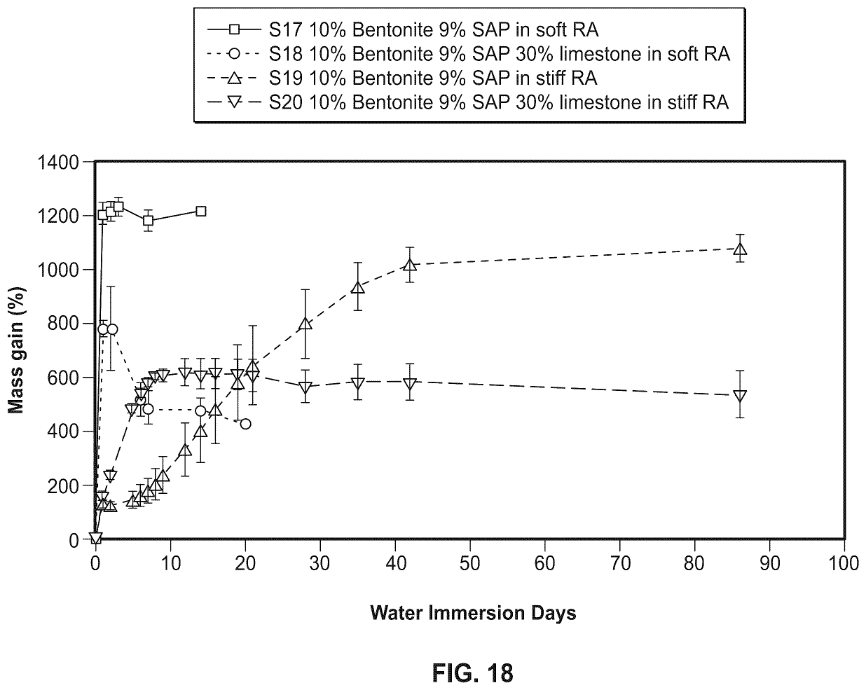

Samples S17-S20 were cut into 150 g samples were shaped and had their swelling evaluated according to the process in example 2. FIG. 18 shows a plot of swelling ((Δ Mass (%)) as a function of water immersion time for Sample Nos. S17-S20. Notably, the stiffer binder provided a delayed swelling in sample S18, similar to example 5 when there was no limestone. Further, when the formulation included limestone such as in S20, the stiff binder prevented limestone the limestone induced deswelling seen in Example 9.

What is claimed is:

1. A waterproofing composition comprising:
a hydrophobic binder, the hydrophobic binder comprising at least one of the following:
a) a polymer modified asphalt comprising asphalt and a polymer additive;
b) a hot melt adhesive; and
c) a thermoplastic polymer;
and
a swellable filler comprising at least one of the following:
(i) at least 15 wt. % and no greater than 85 wt. % of a swellable clay, and
(ii) at least 0.1 wt. % and no greater than 70 wt. % of a super absorbent polymer;
wherein the amounts in wt. % are based on a total weight of the waterproofing composition.

2. The waterproofing composition of claim 1, wherein the swellable clay comprises smectite, bentonite, vermiculite, montmorillonite, nontronite, saponite, or combinations thereof.

3. The waterproofing composition of claim 1, wherein the binder comprises a polymer modified asphalt.

4. The waterproofing composition of claim 1, wherein the waterproofing composition comprises a maximum swelling percentage of at least 25% and no greater than 300% or no greater than 290% or no greater than 280% or no greater than 270% or no greater than 260% or no greater than 250%.

5. The waterproofing composition of claim 1, wherein the waterproofing composition has a swelling per viscosity factor (bentonite) SV_{B} of at least 0.001 mass gain %/cps and no greater than 0.05 mass gain %/cps.

6. The waterproofing composition of claim 1, wherein the polymer additive comprises a styrene-butadiene-styrene rubber.

7. The waterproofing composition of claim 1, wherein the composition comprises a critical filler concentration, C_{f} of at least 10 wt. % and no greater than 80 wt. %.

8. The waterproofing composition of claim 1, wherein the swellable filler comprises the swellable clay and the super absorbent polymer.

9. The waterproofing composition of claim 8, wherein the super absorbent polymer comprises a polyacrylate copolymer, a polyacrylamide copolymer, a polyvinyl alcohol copolymer, polyethylene oxide copolymer, a maleic anhydride copolymer, a cellulose graft copolymer, a starch acrylonitrile graft copolymer or a combination thereof.

10. The waterproofing composition of claim 1, wherein the waterproofing composition has an STᵢ of at least 0.1 days and no greater than 50 days.

11. The waterproofing composition of claim 1, wherein the waterproofing composition has an ST₁₀₀ of at least 0.1 days and no greater than 10 days.

12. The waterproofing composition of claim 1, wherein the waterproofing composition has an ST_{1/2} of at least 0.1 days and no greater than 10 days.

13. The waterproofing composition of claim 1, wherein the waterproofing composition has a swelling per viscosity factor (super absorbent polymer) SV_{P} of at least 0.01 mass gain %/cps no greater than 20 mass gain %/cps.

14. The waterproofing composition of claim 1, further comprising an inert filler.

15. The waterproofing composition of claim 14, wherein the filler comprises limestone, talc, mica, slag, sly ash, cement, hydrate cement, aluminum trihydrate, aluminum oxide, silica (e.g. fume silica, amorphous silica), perlite, rock flower, magnesium hydroxide, magnesium silicate, calcium sulfate, diatomaceous earth, zinc oxide, glass beads, titanium dioxide, zinc borate, kaolin, colemanite, ceramics, carbon black, silica, glass fiber, a fire retardant, a renewable filler, or a combination thereof.

16. The waterproofing composition of claim 14, wherein the inert filler does not contain multivalent cations.

17. The waterproofing composition of claim 14, wherein the inert filler has a dissociation constant, K, of less than 10⁻¹¹.

18. The waterproofing composition of claim 14, wherein the filler comprises a combination of at least one multivalent cationic salt and at least one monovalent cationic salt.

19. A waterproofing article comprising: a first swellable layer adjacent a reinforcing layer wherein the first swellable layer comprises:
the waterproofing composition according to claim 1; or
a layer of swellable clay sandwiched between two hydrophobic binder layers, wherein the hydrophobic binder layer comprises least one of the following:
(i) a polymer modified asphalt comprising asphalt and a polymer additive;
(ii) a hot melt adhesive; and
(iii) a thermoplastic polymer.

20. The waterproofing article of claim 19, wherein the article further comprises a front side configured to adhere to pre- or post-cast concrete or shotcrete and a rear side configured to face soil or a water table.

21. The waterproofing article of claim 19, wherein the reinforcing layer comprises a PET mesh;
a glass mat; a woven or non-woven fabric comprising acrylic acid or acrylate homo or copolymer, polyvinyl chloride, polyethylene terephthalate, neoprene, nylon, polyurethane, or a combination thereof; or a combination thereof.

22. The waterproofing article of claim 19, further comprising a backing disposed over the first swellable layer, such that the backing forms the rear side of the article.

23. The waterproofing article of claim 22, further comprising a second functional layer adjacent the reinforcing layer opposite the first swellable layer wherein the second functional layer comprises: a second hydrophobic binder and an optional a swellable or a non-swellable filler.

24. The waterproofing article of claim 23, further comprising a particulate layer disposed over at least a portion of the second functional layer, such that a plurality of particulate materials are embedded in a top surface of the second functional layer.

25. The waterproofing article of claim 24, wherein the particulate material comprises granules, sand, a swellable clay, cement, hydrated cement, limestone, slag fly ash or a combination thereof.

26. The waterproofing article of claim 24, wherein the particulate material comprises a particle size of at least 10 microns and no greater than 5000.

27. The waterproofing article of claim 23, further comprising a polymeric layer disposed over a portion of the second functional layer, wherein the polymeric layer is configured as a release film, a burn-off film, a sacrificial film or a combination thereof.

28. The waterproofing article of claim 27, wherein the polymeric layer comprises a woven, a nonwoven, a polymer film, wherein the polymeric layer comprises HDPE, PP, or acrylic.

29. The waterproofing article of claim 23, wherein the waterproofing article displays an adhesion to pre or post cast concrete or shotcrete of at least 2 pli and no greater than 50 pli.

30. A waterproofing article comprising:
(i) a backing layer disposed over at least a portion of a first functional layer;
(ii) a reinforcing layer overlying the first functional layer, opposite the backing layer;
(iii) a second functional layer disposed over the reinforcing layer on a side opposite the first functional layer;
(iv) a particulate layer disposed over on at least a portion of the second functional layer, wherein the particulate layer includes a particulate material embedded in a surface of the second functional layer; and
(v) an optional polymeric layer disposed over at least a portion of the second functional layer and or the first functional layer, on a side opposite the reinforcing layer.

31. A method of making a waterproofing composition comprising:
mixing a hydrophobic binder and a swellable filler, the hydrophobic binder comprising at least one of the following:
a) a polymer modified asphalt comprising asphalt and a polymer additive;
b) a hot melt adhesive; and
c) a thermoplastic polymer;
and
a swellable filler comprising at least one of the following:
(i) at least 15 wt. % and no greater than 85 wt. % of a swellable clay, and
(ii) at least 0.1 wt. % and no greater than 70 wt. % of a super absorbent polymer;
wherein the amounts in wt. % are based on a total weight of the waterproofing composition.

32. The method of preparing a waterproofing composition of claim 31, wherein the waterproofing composition comprises the composition of claim 1.

33. A method of making a waterproofing article comprising:
forming a first functional layer by depositing a waterproofing composition onto a reinforcing layer or by depositing a swellable filler sandwiched between two layers of hydrophobic binders onto a reinforcing layer,
the waterproofing composition comprising a hydrophobic binder, the hydrophobic binder comprising at least one of the following:
a) a polymer modified asphalt comprising asphalt and a polymer additive;
b) a hot melt adhesive; and
c) a thermoplastic polymer;
and
a swellable filler comprising at least one of the following:
(i) at least 15 wt. % and no greater than 85 wt. % of a swellable clay, and
(ii) at least 0.1 wt. % and no greater than 70 wt. % of a super absorbent polymer;
wherein the amounts in wt. % are based on a total weight of the waterproofing composition.

34. A method of waterproofing a concrete structure comprising applying a waterproofing article according to claim 19 to a building substrate or concrete form with the releasable material of said membrane facing the area into which the concrete will be cast, and casting concrete such that the concrete contacts the releasable material of the membrane.
